(19) United States
(12) Patent Application Publication
(10) Pub. No.: US 2002/0132627 A1
(43) Pub. Date: Sep. 19, 2002

(54) Information assisting system, information assisting method, information terminal apparatus, and information assisting apparatus

(75) Inventor: Naohiko Ichihara, Saitama-ken (JP)

Correspondence Address: ARENT FOX KINTNER PLOTKIN & KAHN, PLLC, Suite 600, 1050 Connecticut Avenue, N.W., Washington, DC, 20036-5339, US

(73) Assignee: Pioneer Corporation

(21) Appl. No.: 10/098,340

(22) Filed: Mar. 18, 2002

(30) Foreign Application Priority Data
Mar. 19, 2001 (JP) 2001-78596

(51) Int. Cl. H04Q 7/20

(52) U.S. Cl. 455/456

(57) ABSTRACT

To provide an information assisting system, an information assisting method, an information terminal apparatus, and an information assisting apparatus capable of improving convenience to a user. Positioning device for determining a current position of a cellular phone serving as an information terminal apparatus is provided, and an agent function is provided to at least one of the cellular phone and a server serving as an information assisting apparatus, which communicate with each other via a mobile communication network. The agent function judges the circumstance of the user by comparing information on an action plan of the user with information on the current position of the information terminal apparatus which moves along with the user, and upon judging an occurrence of a trouble which affects the action plan of the user, the agent function provides the user with proper information and continues to assist the user in a suitable manner until the desired purpose of the user is achieved.

### BACKGROUND OF THE INVENTION

The present invention relates to an information assisting system, an information assisting method, an information terminal apparatus, and an information assisting apparatus for providing information of various kinds which meets the requirement or suits the purpose of a user or the like (hereinafter, referred to simply as the user) by employing, for example, a mobile communication network.

The application claims priority from Japanese Application No. 2001-078596, the disclosure of which is incorporated herein by reference for all purposes.

A widespread use of a mobile communication network and the Internet promotes the research and development of an information assisting system for distributing and thereby providing information of various kinds to a user-owned information terminal apparatus.

In a conventional information assisting system in which a cellular phone serving as a mobile station can be used as an information terminal apparatus, when a user wishes to obtain desired information, as shown in FIG. 17 by way of example, he transmits search request information to a server 4 owned by an information distributor from a cellular phone 3 via a mobile communication network 1 to have the information (he wishes to obtain) searched.

Upon receipt of the search request information, the server 4 begins a search through its internal database (not shown), and returns (distributes) search result information obtained by the search to the cellular phone 3 via the mobile communication network 1 so as to be provided to the user.

Also, in case that the server 4 made a search through its internal database upon receipt of the search request information from the cellular phone 3 and failed to find information which meets the request from the user, the server 4 transfers the search request information further to another server 5 via an internet 2, and directs the server 5 to make a search through its internal database (not shown).

When the information which meets the request from the user is obtained from the internal database in the server 5 as the result of the search by the server 5, the server 5 returns (transfers) the search result information obtained by the search to the server 4 via the internet 2, and the server 4 distributes the search result information to the cellular phone 3 via the mobile communication network 1 so as to be provided to the user.

As has been discussed, the conventional information assisting system aims to improve convenience to the user by swiftly searching and distributing the information requested by the user.

The conventional information assisting system, however, merely searches for the information at a search request from the user and provides the searched information to the user, and therefore, it cannot be said that the conventional information assisting system provides proper information which meets the need or suits the purpose of the user in a satisfactory manner.

The following description will describe the problems in the conventional information assisting system based on some concrete events.

For example, when the user is going to move from one railway station (start station) to another railway station (destination station), he may wish to search for a train route from the start station to the destination station requiring the shortest time (the shortest route) and an associated timetable (arrival and departure schedules for trains at each station), and then head for the destination station according to the search result. In such a case, the user initially manipulates the cellular phone 3 and transmits search request information to the server 4 to have the shortest route and the associated timetable searched.

Meanwhile, the cellar phone 3 receives the information on the shortest route and the associated timetable distributed from the server 4 as the search result information, and displays the search result information on the display screen so as to be provided to the user. Accordingly, the user takes a train at the start station and heads for the destination station according to the information on the shortest route and the associated timetable thus obtained.

However, because the information on the shortest route and the associated timetable provided to the user is the information available at the time the server 4 made the search at the search request from the user, the information may possibly be changed while the user is on the move, that is, after he takes a train at the start station and before he arrives at the destination station.

For example, in case that the train is not running according to the timetable for some reason, there may occur a problem that the information on the shortest route and the associated timetable the user obtained before he takes a train at the start station does not respond to the circumstances in real time and becomes no longer useful on the way to the destination station.

If such a problem occurs and the user notices the disruptions in the timetable, he may wish to obtain the information on an alternative shortest route. In such a case, however, the user has to transmit a search request again to the server 4 to have the information (on an alternative shortest route from the current midway position to the destination station) and an associated timetable searched.

As has been discussed, the conventional information assisting system has a problem that even when the user obtains the information by taking the time and trouble of transmitting a search request, the information may become useless halfway to the destination, which makes the information assisting system less convenient to the user.

Also, besides the above case of providing the train route and the associated timetable to the user as described in the above, the conventional information assisting system has a problem also in the other cases that it cannot continue to provide proper information which suits the desired purpose of the user in a satisfactory manner until the purpose is achieved.

In other words, the conventional information assisting system handles a job quite simply by merely returning the search result information in response to the search request information transmitted from the user-owned cellular phone 3, and ends the job once it has returned the search result information. This poses a problem that the conventional information assisting system has not realized a system capable of providing proper information which meets the need or suits the purpose of the user. Hence, there has been a demand for an information assisting system capable of further improving convenience to the user.

### SUMMARY OF THE INVENTION

The present invention has been devised to solve the problems in the conventional information assisting system, and therefore, has an object to provide an information assisting system, an information assisting method, an information terminal apparatus, and an information assisting apparatus capable of further improving convenience to the user.

In order to achieve the above and other objects, the present invention is characterized by including: an information terminal apparatus and an information assisting apparatus communicating with each other via a mobile communication network; positioning means for determining a current position of the information terminal apparatus; and agent means provided to at least one of the information terminal apparatus and the information assisting apparatus, and characterized in that the agent means retrieves information pertinent to the current position of the information terminal apparatus from the information assisting apparatus based on information on the current position determined by the positioning means, and supplies the information terminal apparatus with the information retrieved.

The invention is also characterized in that the agent means sets information on an action plan of a user inputted from the information terminal apparatus, compares the information on the action plan set with the information on the current position determined at every predetermined time by the positioning means, and judges an occurrence of a trouble to the user when the information on the current position causes a discrepancy in time or in position with respect to the information on the action plan.

The invention is also characterized in that the agent means sets information on an action plan of a user inputted from the information terminal apparatus, conducts a search through the information assisting apparatus at every predetermined time to obtain information pertinent to the information on the action plan, and judges a circumstance of the user by comparing the information obtained by the search with the information on the current position determined by the positioning means.

The invention is also characterized in that the agent means judges an occurrence of a trouble to the user upon judging that the information obtained by the search includes information pertinent to the information on the current position determined by the positioning means by comparing the information obtained by the search with the information on the current position determined by the positioning means.

The invention is also characterized in that, after the agent means sets the information on the action plan of the user inputted from the information terminal apparatus, the agent means judges the circumstance of the user and the occurrence of a trouble to the user upon supply of information which affects the user from the information assisting apparatus and based on the information supplied.

The invention is also characterized in that, upon judging the occurrence of a trouble, the agent means retrieves information pertinent to the trouble from the information assisting apparatus, and supplies the information terminal apparatus with the information retrieved.

The invention is also characterized in that, when the user enters an assistance continue command in response to the information pertinent to the trouble supplied to the information terminal apparatus, the agent means sets information on an action plan from a position at which the information terminal apparatus was present when the assistance continue command was entered.

According to the present invention, the agent means judges the circumstance of the user by comparing the information on the action plan of the user with the information on the current position of the information terminal apparatus which moves along with the user. Upon judging an occurrence of a trouble which affects the action plan of the user, the agent means provides the user with proper information and continues to assist the user in a suitable manner until the desired purpose of the user is achieved.

### BRIEF DESCRIPTION OF THE DRAWINGS

These and other objects and advantages of the present invention will become clear from the following description with reference to the accompanying drawings, wherein:

FIG. 1 is a view showing an arrangement of an information assisting system according to one embodiment of the present invention;

FIG. 2 is a view showing an arrangement of a mobile communication network;

FIG. 3 is a block diagram showing an arrangement of a cellular phone according to one embodiment of the present invention;

FIG. 4 is a view showing, by way of example, train routes to explain an operation of the information assisting system according to one embodiment of the present invention;

FIG. 5 is a view showing an arrangement of an agent mechanism according to a first embodiment;

FIG. 6 is a flowchart detailing an operation of an information assisting system according to the first embodiment;

FIG. 7 is a view showing, by way of example, a display content on a cellular phone according to the first embodiment;

FIG. 8 is a view showing an arrangement of an agent mechanism according to a second embodiment;

FIG. 9 is a flowchart detailing an operation of an information assisting system according to the second embodiment;

FIG. 10 is a view showing, by way of example, a display content on a cellular phone according to the second embodiment;

FIG. 11 is a view showing an arrangement of an agent mechanism according to a third embodiment;

FIG. 12 is a flowchart detailing an operation of an information assisting system according to the third embodiment;

FIG. 13 is a view showing an arrangement of an agent mechanism according to a fourth embodiment;

FIG. 14 is a flowchart detailing an operation of an information assisting system according to the fourth embodiment;

FIG. 15 is a flowchart detailing an operation of an information assisting system according to a fifth embodiment;

FIG. 16 is a flowchart detailing an operation of an information assisting system according to a sixth embodiment; and

FIG. 17 is a view showing an arrangement of a conventional information assisting system.

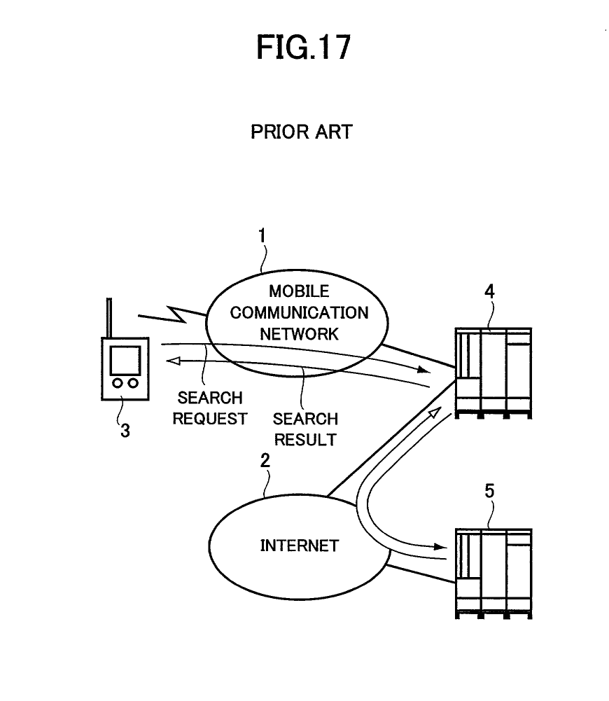

### DETAILED DESCRIPTION OF THE PREFERRED EMBODIMENTS

The following description will describe, with reference to the accompanying drawings, an information assisting system, an information assisting method, an information terminal apparatus, and an information assisting apparatus according to embodiments of the present invention.

(First Embodiment)

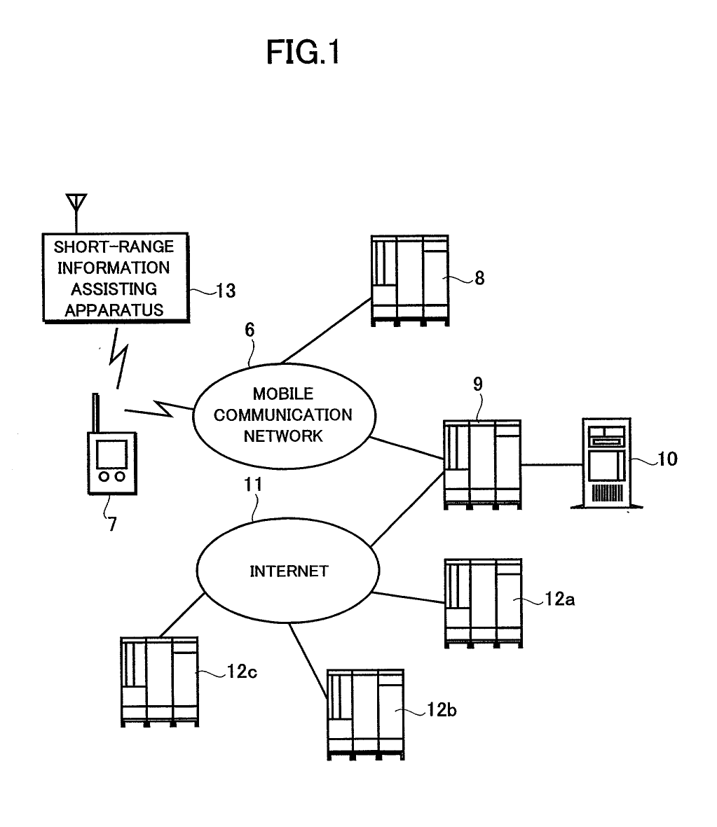

The following description will describe a first embodiment of the present invention with reference to FIGS. 1 through 7. FIGS. 1 through 3 are views showing arrangements of an information assisting system of the present embodiment. In FIG. 1, the information assisting system is of an arrangement employing a communication network including a mobile communication network 6 adopting a wireless communication technique, such as CDMA (Code Division Multiple Access) technique, and an internet 11.

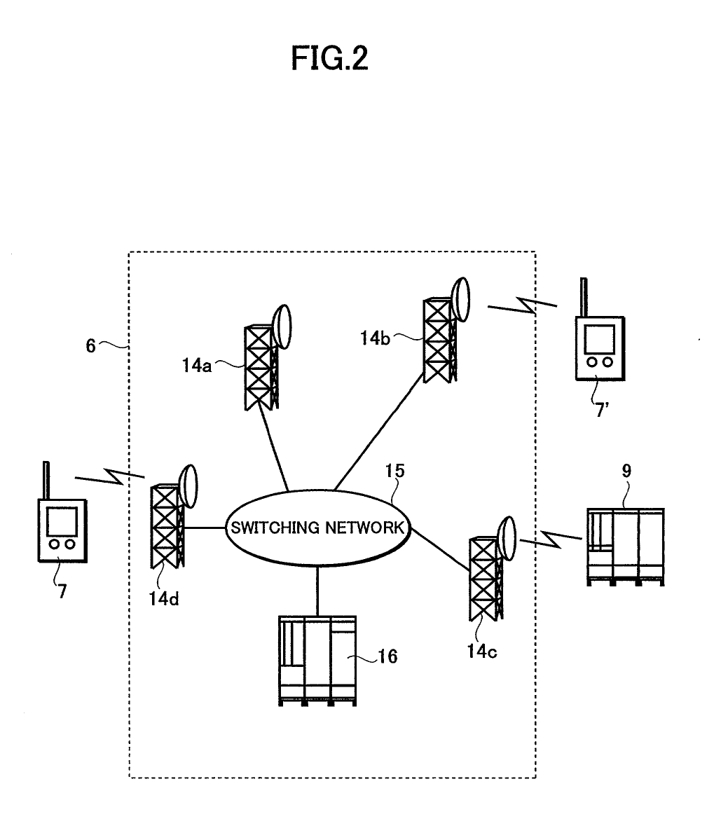

As shown in FIG. 2 by way of example, the mobile communication network 6 is composed of a plurality of base stations 14a, 14b, 14c, 14d, etc. established within the service area, a switching network 15 for switching communication paths among the plurality of base stations, and a switching network control server 16 for controlling switching operations of the switching network 15.

When a network subscriber and user of a cellular phone 7 makes a communication, such as a call and a data communication, with another person using a cellular phone 7′, the switching network control server 16 controls the switching network 15 so as to establish a wireless communication between the cellar phone 7 and the nearby base station 14d and a wireless communication between the cellar phone 7′ and the nearby base station 14b, and further, a communication path between the base stations 14d and 14b, whereby a wireless communication is established between the cellular phones 7 and 7′.

Also, as shown in FIG. 1 by way of example, in case that servers 8, 9, etc. each serving as an information assisting apparatus are networked via the mobile communication network 6 by a provider or the like engaged in assisting the user, so that a wireless communication between the cellular phone 7 and the servers 8, 9, etc. is allowed, the switching network 15 and the switching network control server 16 also establish a communication path between the cellular phone 7 and the servers 8, 9, etc. to make that wireless communication possible.

The information assisting system is constructed by the arrangement including the mobile communication network 6, cellular phone 7 and the like, and the servers 8, 9, etc. Further, as shown in FIG. 1 by way of example, according to the information assisting system, the server 9 is also linked to the internet 11 and connected to a server 10 serving as another information assisting apparatus. By further including an arrangement to network a plurality of servers 12a, 12b, 12c, etc. serving as other information assisting apparatuses via the internet 11, it is possible to arrange the entire system quite extensively and diversely.

Further, the cellular phone 7 makes a communication not only via the mobile communication network 6, but also directly with a server 13 furnished with a short-range wireless communication function and linked to a local area network (LAN) for wireless communications within a relatively limited area in comparison with the mobile communication network 6 and the internet 11, or with other various kinds of electronic equipment 13 furnished with a short-range wireless communication function.

Hence, the information assisting system is of an arrangement including not only the aforementioned mobile communication network 6, internet 11, cellular phone 7 and the like, servers 8, 9, 10, 12a, 12b, 12c, etc., but also the server or electronic equipment 13 for directly making a wireless communication with the cellular phone 7 and the like as the information assisting apparatus.

Hereinafter, the server and various kinds of electronic equipment for directly making a short-range wireless communication with the cellular phone 7 are collectively referred to as a short-range information assisting apparatus 13.

Although it will be described in detail below, it should be noted that, according to the information assisting system, at least one of the servers 8, 9, 10, 12a, 12b, 12c, etc., which make communications via the mobile communication network 6, the internet 11 or the like, is furnished with an agent function so as to function as agent means for independently judging the need or the purpose and the circumstance of the user who owns the cellular phone 7, and then providing proper information which meets the need or suits the purpose of the user according to the judging result.

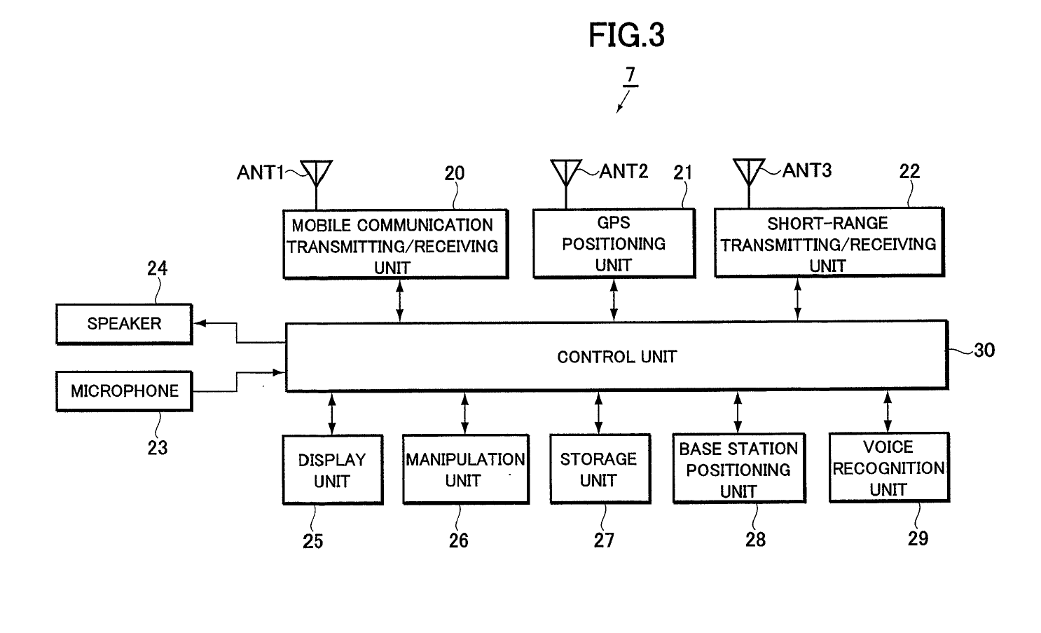

Next, the following description will describe an arrangement of the cellular phone 7 in the present embodiment with reference to the block diagram of FIG. 3.

The cellular phone 7 is provided with a transmitting/receiving antenna ANT1 and a mobile communication transmitting/receiving unit 20 for making a wireless communication via the mobile communication network 6, a GPS (Global Positioning System) antenna ANT 2 and a GPS positioning unit 21 for determining the current position POSIgps of the cellular phone 7 by receiving an arrival radio wave from a GPS satellite present in the GPS, and an antenna ANT3 and a short-range transmitting/receiving unit 22 for making a communication with the short-range information assisting apparatus 13.

The cellular phone 7 is further provided with a microphone 23 and a speaker 24 for enabling the user to make a call to a remote person, a display unit 25, a manipulation unit 26, a storage unit 27, a base station positioning unit 28, a voice recognition unit 29, and a control unit 30 for taking central control on the operations of the entire cellular phone 7.

The mobile communication transmitting/receiving unit 20 is provided with a receiving circuit for decoding a reception signal obtained upon receipt of an arrival radio wave from the mobile communication network 6 at the transmitting/receiving antenna ANT1 and supplying the decoded reception signal to the control unit 30, and a transmitting circuit for modulating transmission information supplied from the control unit 30 into a transmission signal and transmitting the transmission signal to the mobile communication network 6 through the transmitting/receiving antenna ANT 1.

Upon receipt of an arrival radio wave from the GPS satellite at the GPS antenna ANT 2, the GSP positioning unit 21 determines the current position POSIgps of the cellular phone 7 by analyzing the reception signal, which is obtained upon receipt of the arrival radio wave, based on the principle of the so-called triangulation.

The short-range transmitting/receiving unit 22 makes a wireless communication with the short-range information assisting apparatus 13 as has been discussed above. For example, if the short-range information assisting apparatus 13 is provided at a location where a communication range is relatively limited, such as in a train, a large-scale shop like a department store, and a public facility, local information in such a limited location can be obtained by receiving a radio wave transmitted from the short-range information assisting apparatus 13 by means of the short-range transmitting/receiving unit 22.

The display unit 25 is composed of a liquid crystal display or the like. Under the control of the control unit 30, the display unit 25 shows an onscreen display, such as a menu listing the instructions for the user on the manipulation method, input information entered by the user from the manipulation unit 26, and information distributed via the mobile communication network 6 or from the short-range information assisting apparatus 13.

The manipulation unit 26 is provided with a plurality of manipulation keys. When the user manipulates the manipulation keys as needed, the manipulation unit 26 supplies the content of manipulations to the control unit 30 as command information from the user.

The storage unit 27 is composed of a non-volatile rewritable memory or the like, and performs storing jobs, such as storing the information distributed via the mobile communication network 6 or from the short-range information assisting apparatus 13, and pre-storing image data for an onscreen display.

The base station positioning unit 28 obtains predetermined base station identity code information and position information (information on the latitude and longitude of the base station) transmitted from one of the base stations linked to the mobile communication network 6 currently making a communication with the cellular phone 7, and handles the position information POGIbs thus obtained as a pseudo current position of the cellular phone 7 (a position close to the current position of the cellular phone 7).

Although it will be described in detail below, when the current position of the cellular phone 7 is requested from any of the servers serving as the information assisting apparatuses, the control unit 30 transmits the information on the current position POSIgps determined by the GPS positioning unit 21 or on the pseudo current position POGIbs to the requesting server by means of the mobile communication transmitting/receiving unit 20.

Because the current position POSIgps determined by the GPS positioning unit 21 is more accurate than the pseudo current position POGIbs, it may be arranged in such a manner that only the current position POSIgps is transmitted at each request from the server.

Hereinafter, the information on the current position POSIgps or on the pseudo current position POGIbs is referred to as current position information POSI for ease of explanation.

The voice recognition unit 29 recognizes a voice inputted from the microphone 23 and converts the same into character code data when the user specifies the voice input mode by means of the manipulation unit 26. When the user enters a command to transmit the converted character code data to the mobile communication network 6, the voice recognition unit 29 supplies the converted character code data to the mobile communication transmitting/receiving unit 20 so as to be transmitted to the mobile communication network 6 from the transmitting/receiving antenna ANT1.

The voice recognition unit 29 is also furnished with a voice synthesizing function for converting character code data into a voice signal, so that the user can hear the voice signal as the voice recognition unit 29 converts the character code data transmitted via the mobile communication network 6 or from the short-range information assisting apparatus 13 into the voice signal and supplies the same to the speaker 24 at a command from the user.

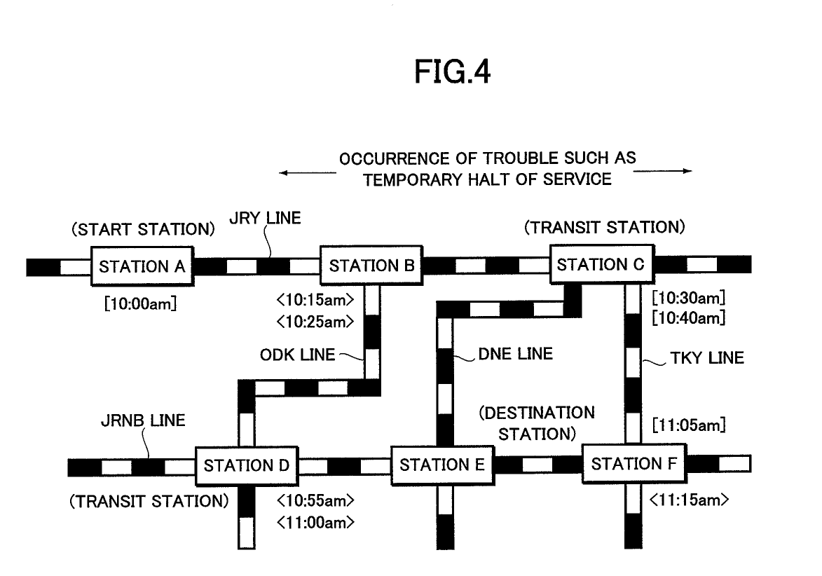

Next, the following description will describe an operation of the above-arranged information assisting system with reference to FIGS. 4 through 7.

Herein, an explanation will be given to an operation of the information assisting system, by way of an example in which, as schematically shown in FIG. 4, the user wishes to move from a start station (station A) to a destination station (station F) by train.

The information assisting system is a system which can be arranged extensively and diversely by networking the servers or the like as needed via a communication network, such as the mobile communication network 6 and the internet 11. Herein, as one example, assume that the server 9 shown in FIG. 1 is a server for accepting an assistance request from the cellular phone 7 as to traffic information and the like, and for providing the cellular phone 7 with the traffic information and the like which meets the need or suits the purpose of the user.

Also, assume that the servers 10, 12a, 12b, 12c, etc. are provided with their respective databases for storing information on the timetable of trains and on the actual operating conditions and traffic information of various kinds, which are provided from time to time by the railway companies who own the railways.

Also, assume that the server 8 serves as an area-specific information distributing server. The area-specific information distributing server referred to herein is a server provided for the task of constantly distributing information of various kinds in real time to the subscribers of the mobile communication network 6 from the antenna of each base station forming the mobile communication network 6.

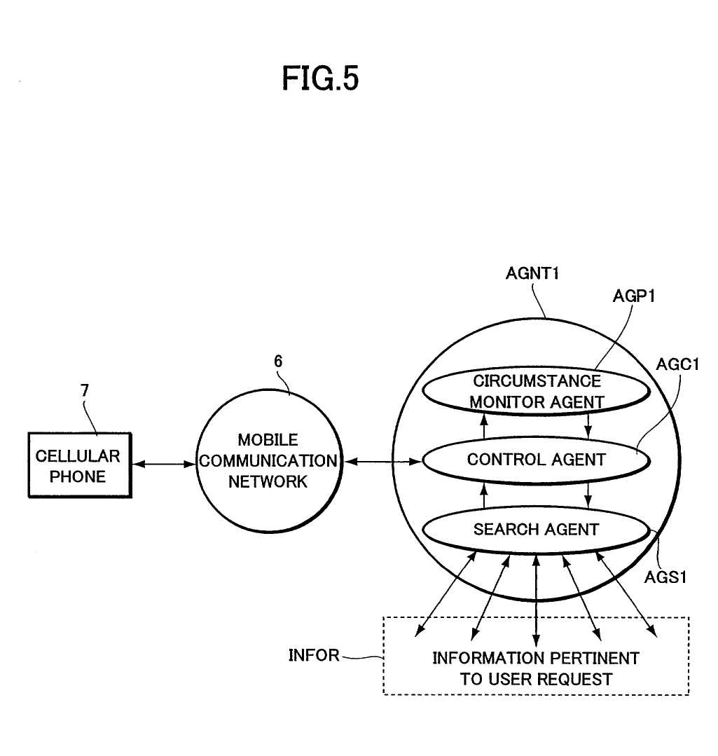

In order to complete a desired action plan, the user manipulates the cellular phone 7 and transmits information indicating an assistance request (hereinafter, referred to as search request information) to the server 9 to obtain the information on the shortest route from the start station (station A) to the destination station (station F) and an associated timetable. Then, upon receipt of the search request information at the server 9, an agent function AGNT1 provided in the server 9 as shown in FIG. 5 starts assisting jobs in a suitable manner to enable the user to achieve his purpose of moving from the start station (station A) to the destination station (station F).

The agent function AGNT1 is realized by running an object-oriented program created according to the communications protocol, such as TCP/IP, FTP, and HTTP, on a computer installed in the server 9, and is composed of a circumstance monitor agent AGP1, a control agent AGC1, and a search agent AGS1.

The control agent AGC1 not only controls the circumstance monitor agent AGP1 and the search agent AGS1, but also performs a user assisting task by analyzing the content of the search request information transmitted from the cellular phone 7 and judging an action plan of the user, that is, the need or the purpose of the user, and then distributing proper information to the user via the mobile communication network 6 according to the judging result.

For example, when the user transmits a search request for a train route from the start station (station A) to the destination station (station F) in the form of the search request information, the control agent AGC1 judges that the purpose of the user is to move from the start station (station A) to the destination station (station F), and continuously performs the user assisting task since the user transmitted the search request until he arrives the destination station (station F).

Further, once the control agent AGC1 starts the user assisting task, it requests the cellular phone 7 to report its current position at every predetermined time T. When the cellular phone 7 transmits the current position information POSI at the request, the control agent AGC1 supplies the received current position information POSI to the circumstance monitor agent AGP1.

The search agent AGS1, in accordance with a command from the control agent AGC1, accesses the servers 10, 12a, 12b, 12c, etc. networked via the mobile communication network 6 and the internet 11, and searches for the information (the information on the shortest route and the associated timetable, etc.) INFOR at the search request from the user. Then, the search agent AGS1 transfers the information INFOR obtained by the search to the control agent AGC1 so as to be distributed to the cellular phone 7 as search result information. The search agent AGS1 supplies the information INFOR thus obtained also to the circumstance monitor agent AGP1.

The circumstance monitor agent AGP1 is furnished with a function of analyzing and judging the current circumstance of the user, and reports the judging results to the control agent AGC1 from time to time.

To be more concrete, the circumstance monitor agent AGP1 analyzes and judges the current circumstance of the user by making a comparison at every predetermined time τ between the current position information POSI transmitted from the cellular phone 7 at every predetermined time τ and the information INFOR obtained as the search result information by the search in response to the search request information.

The circumstance monitor agent AGP1 judges an occurrence of a trouble to the user by checking a case where the current position information POSI transmitted from the cellular phone 7 does not change over a considerable period when the purpose of the user is to move from one place to another, or checking a case where the current position information POSI noticeably deviates from the train route from the start station (station A) to the destination station (station F). Further, upon judging the occurrence of a trouble, the circumstance monitor agent AGP1 notifies (transmits) occurrence-of-trouble notice information informing the occurrence of a trouble to the cellular phone 7 by means of the control agent AGC1.

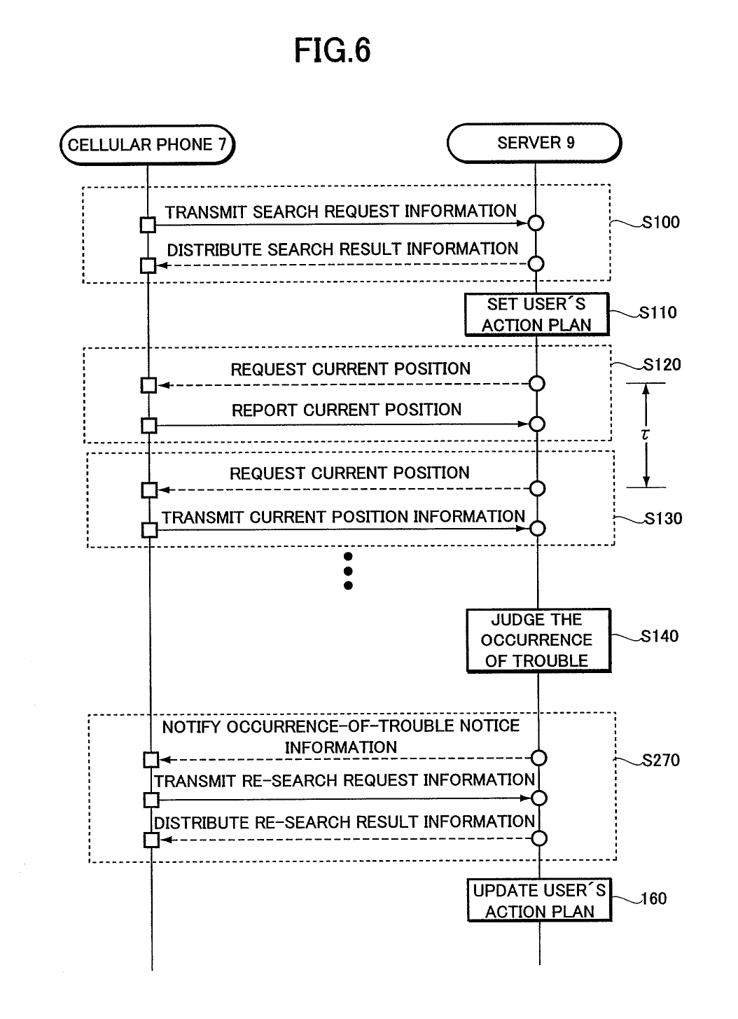

Next, the following description will describe a more concrete operation of the information assisting system with reference to the flowchart of FIG. 6.

In Step S100, the user manipulates the cellular phone 7 and transmits to the server 9 the search request information indicating that he wishes to obtain the information on the shortest route from the start station (station A) to the destination station (station F) and an associated timetable. Accordingly, upon receipt of the search request information at the server 9, the control agent AGC1 is activated.

Then, the control agent AGC1 specifies the cellular phone 7 (which needs the assistance) based on its phone number or the like. Meanwhile, the control agent AGC1 analyzes the content of the search request information and judges that the purpose of the user is to move from the start station (station A) to the destination station (station F). Subsequently, the control agent AGC1 instrcts the search agent AGS1 to search for the information on the shortest route from the start station (station A) to the destination station (station F) and the associated timetable which meets the search request.

Here, the search agent AGS1 searches for the servers handling traffic information, and when it finds the servers 8, 10, 12a, 12b, 12c etc. handling the traffic information, it accesses these servers and obtains the information INFOR on the shortest route from the start station (station A) to the destination station (station F) and the associated timetable which meets the search request. Then, the search agent AGS1 supplies the information INFOR obtained by the search to the circumstance monitor agent AGP1, so that the control agent AGC1 distributes the information INFOR (as the search result information) to the cellular phone 7 via the mobile communication network 6.

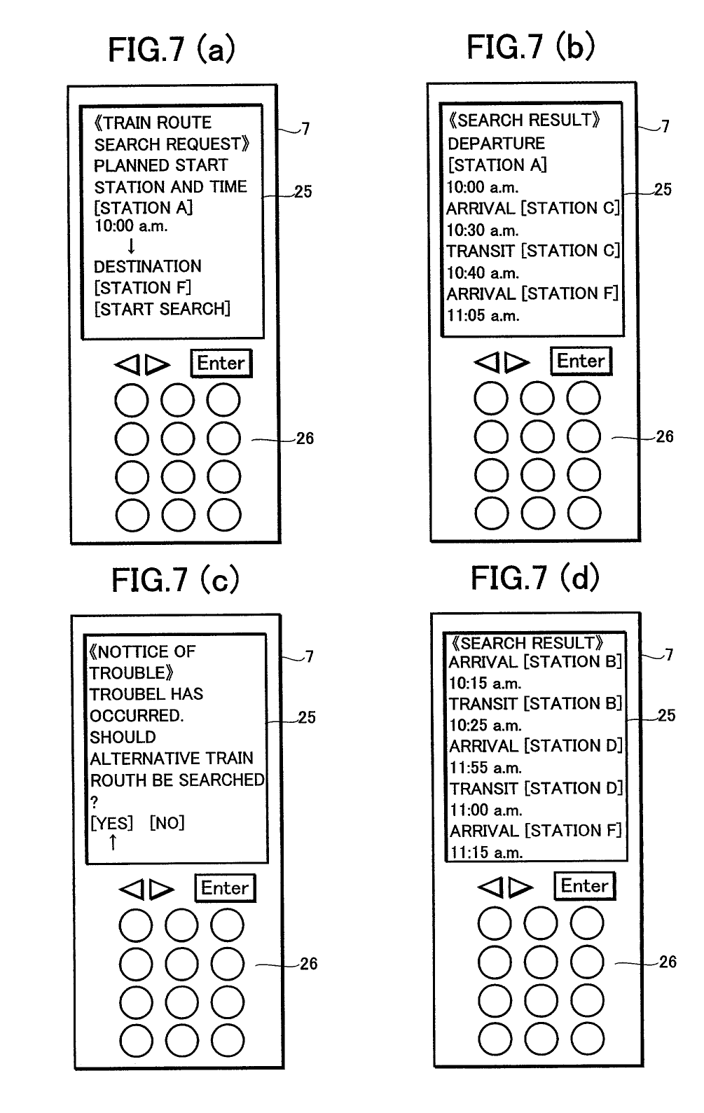

When the user manipulates the manipulation unit 26 and transmits the search request, the control unit 30 displays, as shown in FIG. 7(a), a predetermined menu on the display screen of the display unit 25. The user specifies the desired start station (station A) and destination station (station F) from the manipulation unit 26 according to the onscreen menu, and when the user depresses the Enter key, the content of the search request is transmitted to the server 9 as the search request information.

Also, when the search result information is distributed to the cellular phone 7 from the server 9, the cellular phone 7 displays, as shown in FIG. 7(b), the stations along the shortest route and the associated timetable showing the arrival and departure times of trains he is supposed to take, which are included in the search result information, on the display screen of the display unit 25.

According to the train routes shown in FIG. 4, the start station (station A) and the stations B and C are on the JRY LINE railway, and the destination station (station F) is on the TKY LINE connected to the station C. Thus, if the user wishes to move using the shortest route, he has to change trains from the one on the JRY LINE railway to the one on the TKY LINE railway when he arrives the transit station (station C).

Even in such a case, the search agent AGS1 judges the most convenient transit station (station C) during the search, and distributes the obtained search result information. Hence, as shown in FIG. 7(b), a message informing that the user needs to change trains at the transit station (station C) and the arrival and departure times of the train he is supposed to take at the transit station (station C) are displayed on the display screen of the display unit 25.

Then, after the jobs in Step S100 are completed, the user takes a train at the start station (station A) at the time specified by the search result information, for example, at 10:00 a.m., and heads for the destination station (station F).

Then, in Step S110, the control agent AGC1 sets the information on the shortest route from the start station (station A) to the destination station (station F) and the associated timetable as action plan information indicating an action plan of the user, and directs the circumstance monitor agent AGP1 and the search agent AGS1 to respectively start to judge the circumstance and to search for the information in a way which suits the action plan of the user.

In subsequent Step S120, the control agent AGC1 transmits the current position request information to the cellular phone 7 to obtain the current position information POSI.

Upon receipt of the current position request information, the cellular phone 7 reports (transmits) the current position information POSI, which is the information on the aforementioned current position POSIgps or pseudo current position POSIbs, to the server 9 by means of the mobile communication transmitting/receiving unit 20.

When the predetermined time τ has passed, the same jobs as in Step S120 are repeated by the control agent AGC1 and the cellular phone 7 in Step S130, and thereafter, the same jobs as in Steps S120 and S130 are repeated at every predetermined time τ.

By repeating the same jobs as in Steps S120 and S130 at every predetermined time τ, the circumstance monitor agent AGP1 checks a change in the moved position of the user based on the current position information POSI and judges any abnormality with such a change in the moved position. In other words, even when the user is supposedly moving from the start station (station A) to the destination station (station F), by checking a case where the current position information POSI transmitted from the cellular phone 7 does not change over a considerably long period, or by checking a case where the current position information POSI noticeably deviates from the train route from the start station (station A) to the destination station (station F),the circumstance monitor agent AGPL can judge a trouble which affects the user.

To be more concrete, the circumstance monitor agent AGP1 handles a change in the current position information POSI transmitted from the cellular phone 7 at every predetermined time τ as actual action information of the user, and compares the actual action information with the action plan information found from the information INFOR on the shortest route and the associated timetable, all in terms of time and position. In other words, the actual action information includes the position information indicated by the current position information POSI of the cellular phone 7 and the time information at every predetermined time τ, whereas the action plan information includes the position information along the train route from the start station (station A) to the destination station (station F) and the time information indicating the running schedule of trains.

Hence, by comparing the actual action information with the action plan information, it is possible to quantitatively determine discrepancies of the actual action information with respect to the action plan information as a difference in time and a difference in position, and only when the difference in time or the difference in position exceeds their respective predetermined reference values, the circumstance monitor agent AGP1 judges the occurrence of a trouble to the user in Step S140.

Then, upon judging the occurrence of a trouble, the circumstance monitor agent AGPL notifies (transmits), in Step S150, the occurrence-of-trouble notice information, which includes information informing the occurrence of a trouble and information requesting the user a command as to whether the assistance needs to be continued, to the cellular phone 7 by means of the control agent AGC1.

Because the present case is an example case where the user moves by train, the information requesting the user whether an alternative shortest route to the destination station (station F) needs to be searched is included in the trouble-of-trouble notice information as the information requesting the user a command as to whether the assistance needs to be continued, and is then notified (transmitted) to the cellular phone 7.

Here, upon receipt of the occurrence-of-trouble notice information, the cellular phone 7 displays, as shown in FIG. 7(c), the content of the occurrence-of-trouble notice information on the display screen of the display unit 25.

Then, the user reviews the display content of the occurrence-of-trouble notice information as shown in FIG. 7(c) and if he wishes to have an alternative shortest route be searched, he manipulates a predetermined manipulation key provided in the manipulation unit 26 and moves a cursor display “↑” onto an YES region on the display screen, and depresses the Enter key, whereupon re-search request information indicating a second search request in continuing to assist the user is transmitted to the server 9.

When the user moves the cursor display “↑” onto a NO region on the display screen and depresses the Enter key, job end information is transmitted from the cellular phone 7 to the server 9, whereupon the agent function AGNT1 terminates the job.

Upon receipt of the re-search request information at the server 9, the control agent AGC1 judges that the assisting job needs to be continued, and directs the search agent AGS1 to search for an alternative shortest route and an associated timetable.

For example, suppose that the user's train becomes unable to run according to the timetable while the user is on the way from the start station (station A) to the stopover station (station B) because the train preceding the user's train has a trouble somewhere between the stopover station (station B) and the transit station (station C) and the service is halted temporarily between the stopover station (station B) and the transit station (station C). In such a case, the user transmits the re-search request information, and the search agent AGS1 searches for an alternative shortest route and an associated timetable. Hence, upon judging the occurrence of a trouble to the user in Step S140, the search agent AGS1 searches for the shortest route from the current position of the user, which is already determined from the latest current position information POSI or by a comparison between the actual action information and the action plan information, to the destination station (station F) and an associated timetable, that is, the shortest route to the destination station (station F) bypassing the transit station (station C) and an associated timetable.

Accordingly, the control agent AGCL transmits (distributes) re-search result information obtained by the second search to the cellular phone 7. Further, in Step S160, the control agent AGC1 sets the information on the shortest route and the associated timetable obtained by the second search as the new action plan information, and thereafter, the circumstance monitor agent AGP1 analyzes and judges the circumstance of the user based on the updated action plan information.

Upon receipt of the re-search result information, the cellular phone 7 provides the same to the user by displaying, as shown in FIG. 7(d), the shortest route from the stopover station (station B) to the destination station (station F) and the associated timetable searched again on the display screen of the display unit 25.

According to an example display of the shortest route shown in FIG. 7(d), when the user's train arrives the station B at 10:15 a.m., he changes trains at the station B to the train on the ODK LINE railway leaving at 10:25 a.m. Then, when the changed train arrives the station D at 10:55 a.m., he again changes trains at the station D to the train on the JRNB LINE railway leaving at 11:00 a.m., which enables the user to arrive the destination station (station F) at 11:15 a.m.

After the jobs in Step S160 are completed, jobs in Steps S120 through S160 are repeated under the control of the control agent AGC1 in continuing to assist the user by distributing proper information which meets the need or suits the purpose of the user. Upon judgment of the user's arrival at the destination station (station F) by the control agent AGC1 based on the current position information POSI, the agent function AGNT1 terminates the assisting job.

As has been discussed, according to the present embodiment, when the user transmits a request to search for desired information from the cellular phone 7 to the server 9, the server 9 judges the need or the purpose of the user by means of the agent function AGNT1, and distributes proper information until the desired purpose of the user is achieved in continuing to assist the user by judging the circumstance of the user from time to time.

Consequently, it is possible to provide elaborate assistance which meets the need or suits the purpose of the user unlike the conventional information assisting system which merely searches for the requested information and distributes the same to the cellular phone 7.

In addition, the agent function AGNT1 judges the circumstance of the user by using a change in the current position information POSI indicating the position of the cellular phone 7 at every predetermined time τ (that is, the action plan information) as the judging material. Hence, it can judge in real time whether the user is in a circumstance which meets the need or suits the purpose of the user, and therefore, is able to provide elaborate assistance which meets the need or suits the purpose of the user.

(Second Embodiment)

Next, the following description will describe a second embodiment of the present invention with reference to FIGS. 1 through 5 and FIGS. 7 through 10. An information assisting system of the present embodiment is of the same arrangement as described in the first embodiment with reference to FIGS. 1 through 3 and FIG. 5.

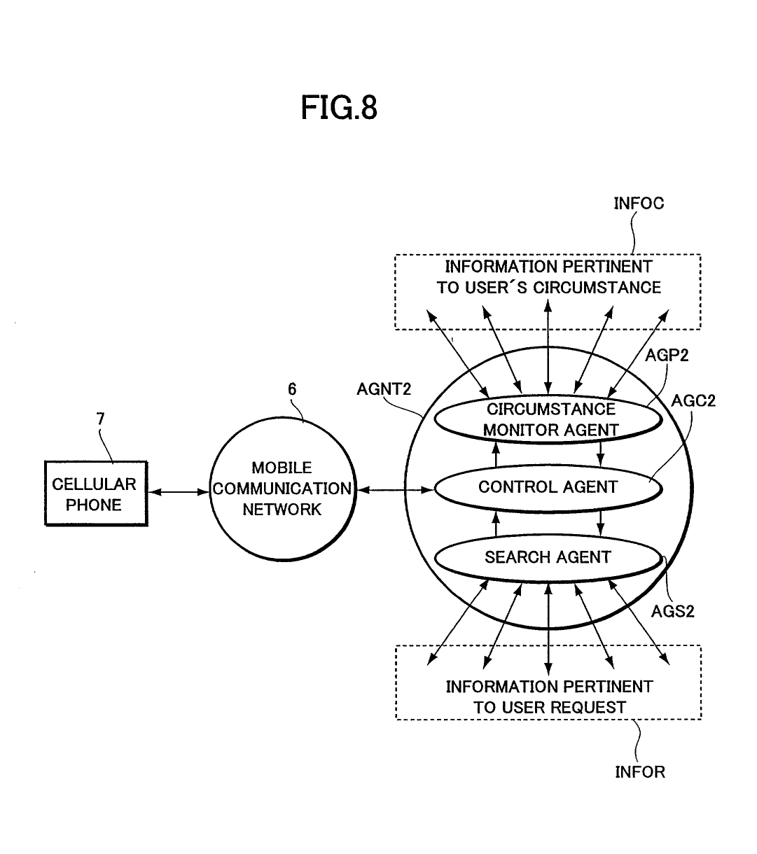

It should be noted, however, that an agent function AGNT2 shown in FIG. 8 furnished with an additional function compared with the agent function AGNT1 shown in FIG. 5 is used in the present embodiment.

The agent function AGNT2 of the present embodiment is composed of a circumstance monitor agent AGP2, a control agent AGC2, and a search agent AGS2, and is realized by running an object-oriented program created according to the predetermined communications protocol on a computer installed in the server 9 shown in FIG. 1.

The control agent AGC2 and the search agent AGS2 are respectively furnished with the same functions as those of the control agent AGC1 and the search agent AGS1 shown in FIG. 5.

In other words, the control agent AGC2 shown in FIG. 8 controls the circumstance monitor agent AGP2 and the search agent AGS2, and the search agent AGS2 searches for the information INFOR requested by the search request information from the user at a command from the control agent AGC2.

Like the circumstance monitor agent AGP1 described in the first embodiment, the circumstance monitor agent AGP2 is provided with a judging function of analyzing and judging the current circumstance of the user by making a comparison at every predetermined time τ between the actual action information found from the current position information POSI transmitted from the cellular phone 7 at every predetermined time τ and the action plan information found from the information INFOR obtained as search result information by the search in response to the search request information. In addition, the circumstance monitor agent AGP2 is furnished with a retrieval function of accessing the servers networked via the mobile communication network 6 or the internet 11 to obtain pertinent information INFOC describing the current circumstance of the user in response to the judging result.

Then, the circumstance monitor agent AGP2 notifies the information INFOC thus retrieved to the control agent AGC2 as retrieval result information, so that the retrieval result information is included in the occurrence-of-trouble notice information descried in the first embodiment and is then notified (transmitted) to the cellular phone 7.

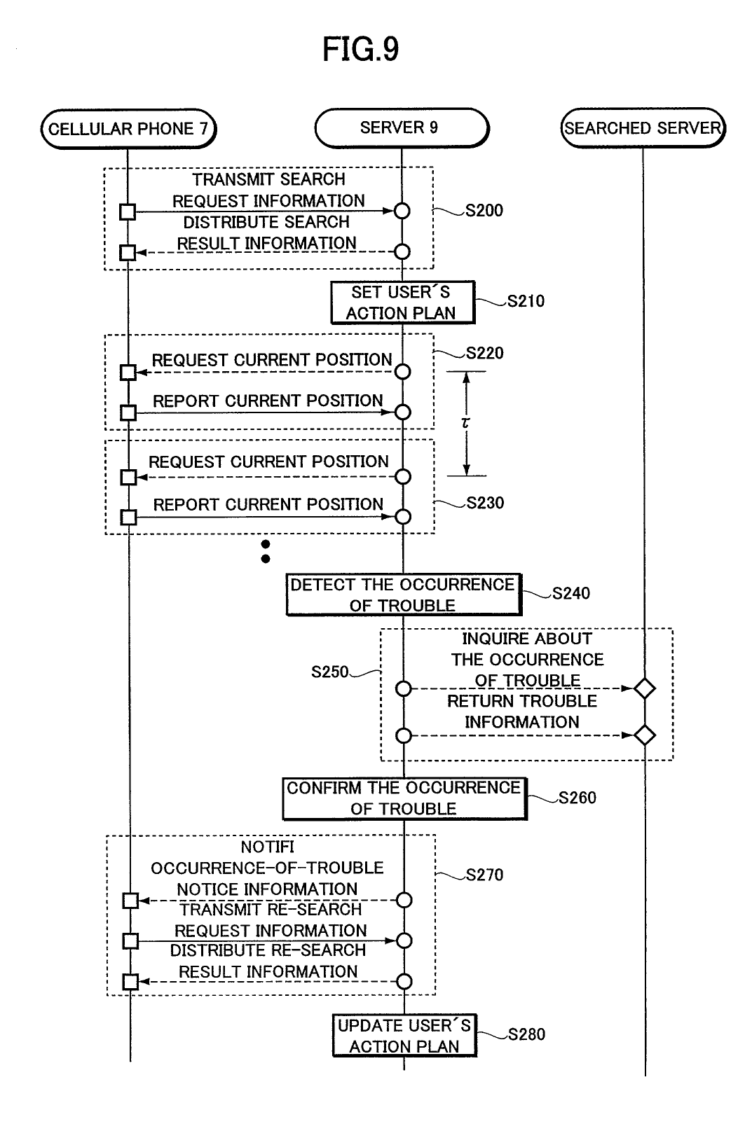

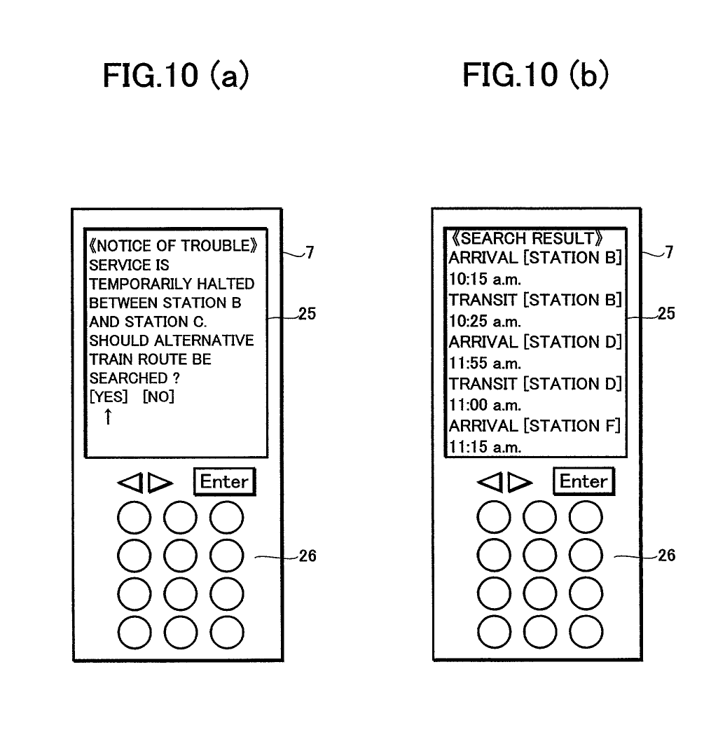

Next, the following description will describe an operation of the above-arranged information assisting system of the present embodiment with reference to FIGS. 9 and 10. Herein, an explanation will be given to an operation of the information assisting system in an example case where the user wishes to move from the start station (station A) to the destination station (station F) via train routes shown in FIG. 4.

In Step S200 in FIG. 9, the user manipulates the cellular phone 7 by reviewing the screen of the display unit 25 shown in FIG. 7(a) and transmits the search request information indicating that he wishes to obtain the information on the shortest route from the start station (station A) to the destination station (station F) and an associated timetable to the server 9. Accordingly, upon receipt of the search request information at the server 9, the control agent AGC2 is activated.

Then, the control agent AGC2 specifies the cellular phone 7 which needs the assistance based on its phone number or the like. Meanwhile, the control agent AGC2 directs the search agent AGS2 to search for the information on the shortest route from the start station (station A) to the destination station (station F) and the associated timetable which meets the search request.

Here, the search agent AGS2 searches for the servers handling traffic information, and when it finds the servers 8, 10, 12a, 12b, 12c, etc. handling the traffic information, it accesses these servers and searches for the information INFOR on the shortest route from the start station (station A) to the destination station (station F) and the associated timetable which meets the search request. Then, the search agent AGS2 distributes the information INFOR obtained by the search to the cellular phone 7 via the mobile communication network 6 by means of the control agent AGC2 as the search result information.

When the search result information is distributed to the cellular phone 7 from the server 9, the cellular phone 7 displays, as shown in FIG. 7(b), the search result information on the display screen of the display unit 25.

Further, the control agent AGC2 checks the content of the search request information from the user, and judges that the purpose of the user is to move from the start station (station A) to the destination station (station F).

Then, after the jobs in Step S200 are completed, the user takes a train at the start station (station A) which is scheduled to leave at the time specified by the search result information, for example, at 10:00 a.m., and heads for the destination station (station F).

In subsequent Step S210, the control agent AGC2 sets the information on the shortest route from the start station (station A) to the destination station (station F) and the associated timetable as action plan information of the user, and directs the circumstance monitor agent AGP2 and the search agent AGS2 to respectively start to judge the circumstance and to search for the information in a way which suits the action plan of the user.

In subsequent Step S220, the control agent AGC2 transmits the current position request information to the cellular phone 7 to obtain the current position information POSI.

Upon receipt of the current position request information, the cellular phone 7 transmits the current position information POSI to the server 9 by means of the mobile communication transmitting/receiving unit 20.

Further, when the predetermined time τ has passed, the same jobs in Step S220 are repeated by the control agent AGC2 and the cellular phone 7 in Step S230, and thereafter, the jobs in Steps S220 and S230 are repeated at every predetermined time τ.

By repeating the jobs in Steps S220 and S230 at every predetermined time τ, the circumstance monitor agent AGP2 checks a change in the moved position of the user based on the current position information POSI and judges any abnormality with such a change in the moved position.

In other words, as was described in the first embodiment, by setting a change in the current position information POSI transmitted from the cellular phone 7 at every predetermined time τ as the actual action information of the user, and comparing the actual action information with the action plan information set in Step S210 in terms of time and position, discrepancies of the actual action information with respect to the action plan information are determined quantitatively as a difference in time and a difference in position, and only when the difference in time or the difference in position exceeds their respective predetermined reference values, the circumstance monitor agent AGP2 judges the occurrence of a trouble to the user in Step S240. Further, in Step S250, the circumstance monitor agent AGP2 starts a retrieval job of finding a cause or the like of the trouble.

In Step S250, the circumstance monitor agent AGP2 makes an inquiry about the occurrence of a trouble to the servers 8, 10, 12a, 12b, 12c, etc. handling the traffic information, and requests them to return information INFOC pertinent to the occurrence of a trouble provided from the railway companies as retrieval information. Further, the circumstance monitor agent AGP2 notifies the control agent AGC2 of the retrieval information, so that the control agent AGC2 makes a final confirmation of the occurrence of a trouble (Step S260).

In subsequent Step S270, the control agent AGC2 notifies (transmits) the cellular phone 7 of the retrieval information and the occurrence-of-trouble notice information including information requesting the user a command as to whether an alternative shortest route to the destination station (station F) needs to be searched, that is, whether the assistance needs to be continued.

Then, upon receipt of the occurrence-of-trouble notice information, the cellular phone 7 displays, as shown in FIG. 10(a), the content of the occurrence-of-trouble notice information on the display screen of the display unit 25.

Because the occurrence-of-trouble notice information includes the retrieval information, the information on the cause of the trouble is displayed, which makes it possible to provide more proper information to the user.

For example, in case that the cause of the trouble is a temporary halt of the service between the stopover station (station B) and the transit station (station C) shown in FIG. 4, a message which reads “SERVICE IS TEMPORARILY HALTED BETWEEN STATION B AND STATION C”, is displayed on the display screen of the display unit 25 based on the retrieval information retrieved by the circumstance monitor agent AGP2. Further, another message is displayed, requesting the user a command as to whether an alternative route needs to be searched in continuing to assist the user.

When the user enters a command “YES” with predetermined manipulations, re-search request information requesting a second search is transmitted to the server 9. When the user enters a command “NO”, job end information is transmitted from the cellular phone 7 to the server 9, and the agent function AGNT2 terminates the job.

Upon receipt of the re-search request information at the server 9, the control agent AGC2 directs the search agent AGS2 to search for an alternative shortest route and an associated timetable.

For example, in case that the control agent AGC2 receives the re-search request information while the user is somewhere between the start station (station A) and the stopover station (station B) due to a temporary halt of the service between the stopover station (station B) and the transit station (station C), then, the search agent AGS2, knowing that the user is somewhere between the start station (station A) and the stopover station (station B), searches for an alternative shortest route to the destination station (station F) bypassing the transit station (station C) and an associated timetable.

Accordingly, the re-search result information obtained by the second search is transmitted (distributed) from the control agent AGC2 to the cellular phone 7. Further, upon receipt of the re-search result information, the cellular phone 7 provides the same to the user by displaying, as shown in FIG. 10(b), the shortest route from the stopover station (station B) to the destination station (station F) and the associated timetable searched again on the display screen of the display unit 25.

In subsequent Step S280, the control agent AGC2 sets the information on the shortest route and the associated timetable obtained by the second search as the new action plan information, and thereafter, the jobs in Steps S220 through S280 are repeated.

Upon judgment of the user's arrival at the destination station (station F) by the control agent AGC2 based on the current position information POSI, the agent function AGNT2 terminates the job.

As has been discussed, the present embodiment is furnished with a further improved agent function in comparison with the first embodiment above, and if the occurrence of any trouble to the user is judged, information related to a cause of the trouble is retrieved upon the judgment and is provided to the user, which makes it possible to provide information enabling the user to make an accurate judgment. Consequently, not only can convenience be improved further, but also elaborate assistance which meets the need or suits the purpose of the user can be provided.

(Third Embodiment)

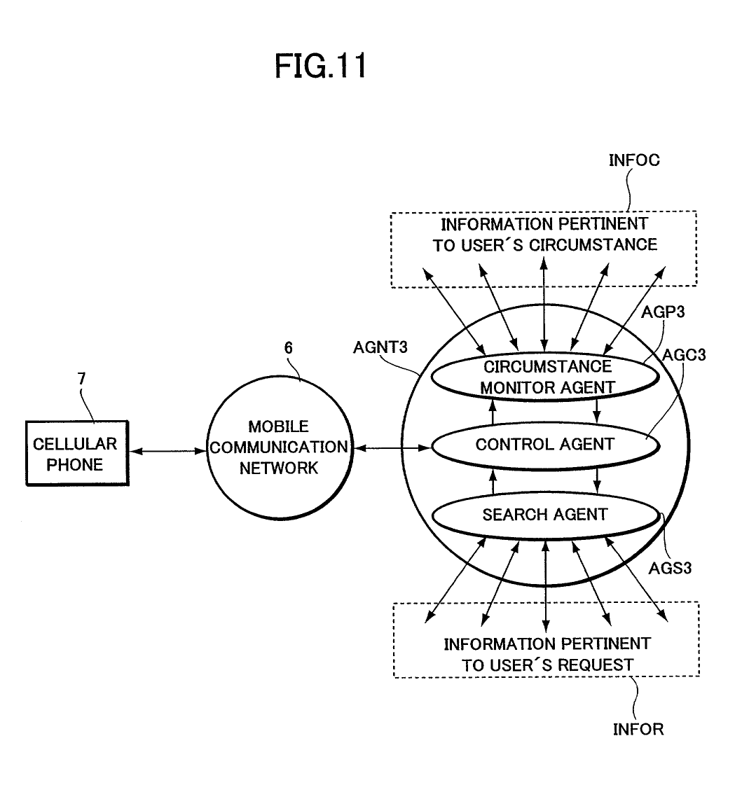

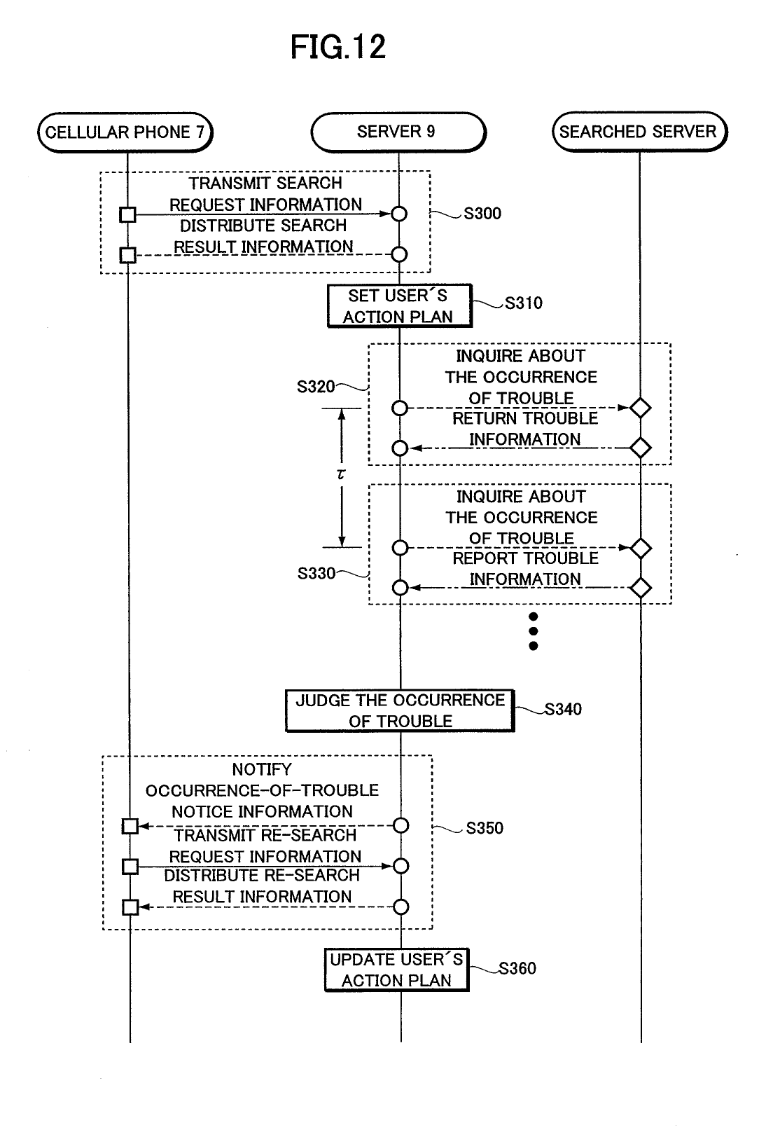

Next, the following description will describe a third embodiment of the present invention with reference to FIGS. 11 and 12.

An information assisting system of the present embodiment is of the same arrangement as described in the first embodiment with reference to FIGS. 1 through 3 except that an agent function AGNT3 equivalent to the agent function AGNT2 described in the second embodiment is provided to the server 9.

It should be noted, however, that the agent function AGNT3 of the present embodiment is different from the above-discussed agent function AGNT2 in the points as follows. That is, a control agent AGC3 and a search agent AGS3 forming the agent function AGNT3 of the present embodiment respectively function in the same manner as the control agent AGC2 and search agent AGS2, but a circumstance monitor agent AGP3 functions differently from the circumstance monitor agent AGP2.

To be more specific, the circumstance monitor agent AGP2 of the second embodiment analyzes and judges the circumstance of the user based on the current position information POSI transmitted from the cellular phone 7. On the contrary, the circumstance monitor agent AGP3 is furnished with a retrieval function for independently retrieving information INFOC pertinent to the circumstance of the user by accessing the servers networked via the mobile communication network 6 or the internet 11 when the control agent AGC3 receives the search request information from the user.

When the circumstance monitor agent AGP3 obtains the information INFOC pertinent to the circumstance of the user, the control agent AGC3 transmits the information INFOC as being included in the occurrence-of-trouble notice information to the cellular phone 7.

Next, the following description will describe an operation of the above-arranged information assisting system with reference to the flowchart of FIG. 12. Herein, an explanation will be given to an operation of the information assisting system in an example case where the user wishes to move from the start station (station A) to the destination station (station F) via train routes shown in FIG. 4.

In Step S300 in FIG. 12, the user manipulates the cellular phone 7 by reviewing the screen of the display unit 25 shown in FIG. 7(a) and transmits the search request information indicating that he wishes to obtain the information on the shortest route from the start station (station A) to the destination station (station F) and an associated timetable to the server 9. Accordingly, upon receipt of the search request information at the server 9, the control agent AGC3 is activated.

Then, the control agent AGC3 specifies the cellular phone 7 which needs the assistance based on its phone number or the like. Meanwhile, the control agent AGC3 directs the search agent AGS3 to search for the information on the shortest route from the start station (station A) to the destination station (station F) and the associated timetable which meets the search request.

Here, the search agent AGS3 searches for the information INFOR on the shortest route from the start station (station A) to the destination station (station F) and the associated timetable which meets the search request through the servers 8, 10, 12a, 12b, 12c, etc. handling the traffic information. Then, the control agent AGC3 distributes the information INFOR to the cellular phone 7 via the mobile communication network 6 as search result information.

Upon receipt of the search result information, the cellular phone 7 displays, as shown in FIG. 7(b), the search result information on the display screen of the display unit 25.

Further, the control agent AGC3 checks the content of the search request information from the user, and judges that the purpose of the user is to move from the start station (station A) to the destination station (station F). Then, the control agent AGC3 notifies the circumstance monitor agent AGP3 and the search agent AGS3 of the judging result and directs the circumstance monitor agent AGP3 and the search agent AGS3 to respectively start to judge the circumstance and to search for the information in a way which meets the need or suits the purpose of the user.

Then, after the jobs in Step S300 are completed, the user takes a train at the start station (station A) which is scheduled to leave at the time specified by the search result information, for example, at 10:00 a.m., and heads for the destination station (station F).

In subsequent Step S310, the control agent AGC3 sets the information on the shortest route from the start station (station A) to the destination station (station F) and the associated timetable as action plan information of the user.

Subsequently, as shown in Steps S320 and S321, the circumstance monitor agent AGP3 conducts retrieval independently at every predetermined time τ and makes an inquiry about the occurrence of a trouble to the servers networked via the mobile communication network 6 or the internet 11 by accessing these servers to obtain the information INFOC pertinent to the circumstance of the user. Upon receipt of trouble information reporting the absence of a trouble, the circumstance monitor agent AGP3 repeats the independent retrieval at every predetermined time τ. Upon receipt of trouble information reporting the occurrence of a trouble, the circumstance monitor agent AGP3 judges whether the trouble information INFOC affects the user, and upon so judging, it notifies the control agent AGC3 of the trouble information INFOC, so that the control agent AGC3 makes a final judgment as to the occurrence of a trouble (Step S340).

In other words, the circumstance monitor agent AGP3 does not judge the occurrence of a trouble by merely obtaining the information INFOC, but it analyzes whether the information INFOC affects the user first, and thence it makes a final judgment as to the occurrence of a trouble only when it judges that the information INFOC affects the user.

For example, when the circumstance monitor agent AGP3 obtains the trouble information INFOC reporting that the service between the station B and the transit station (station C) shown in FIG. 4 is temporarily halted, it analyzes the current position of the user from the current time, and judges the occurrence of a trouble if it judges that the user is heading for the station B from the start station (station A).

Alternatively, when the circumstance monitor agent AGP3 obtains the information INFOC pertinent to the occurrence of a trouble, the control agent AGC3 may request the cellular phone 7 to return the current position information POSI, so that the circumstance monitor agent AGP3 analyzes the current position of the user based on the current position information POSI thus returned, and only when the user is heading for the station B from the start station (station A), it judges that the trouble information INFOC includes information which affects the user, and thereby judges the occurrence of a trouble.

In subsequent Step S350, the control agent AGC3 notifies (transmits) the cellular phone 7 of the trouble information INFOC and the occurrence-of-trouble notice information including information requesting the user a command as to whether an alternative shortest route to the destination station (station F) needs to be searched.

Upon receipt of the occurrence-of-trouble notice information, the cellular phone 7 displays, as shown in FIG. 10(a), the content of the occurrence-of-trouble notice information on the display screen of the display unit 25.

Here, because the occurrence-of-trouble notice information includes the trouble information INFOC pertinent to the occurrence of a trouble, the cause or the like of the trouble is displayed, which makes it possible to provide the user with more proper information.

For example, in case that the cause of a trouble is a temporary halt of the service between the stopover station (station B) and the transit station (station C), a message which reads “SERVICE IS TEMPORARILY HALTED BETWEEN STATION B AND STATION C” is displayed on the display screen of the display unit 25. Further, another message is displayed, requesting the user a command as to whether an alternative train route needs to be searched.

When the user enters a command “YES” with predetermined manipulations, re-search request information requesting a second search is transmitted to the server 9. When the user enters a command “NO”, job end information is transmitted from the cellular phone 7 to the server 9, and the agent function AGNT3 terminates the job.

Upon receipt of the re-search request information at the server 9, the control agent AGC3 directs the search agent AGS3 to search for an alternative shortest route and an associated timetable.

For example, in case that the control agent AGC3 receives the re-search request information while the user is somewhere between the start station (station A) and the stopover station (station B) due to a temporary halt of the service between the stopover station (station B) and the transit station (station C), then, the search agent AGS3 searches for an alternative shortest route to the destination station (station F) bypassing the transit station (station C) and an associated timetable.

Accordingly, re-search result information obtained by the second search is transmitted (distributed) from the control agent AGC3 to the cellular phone 7.

Upon receipt of the re-search result information, the cellular phone 7 provides the same to the user by displaying, as shown in FIG. 10(b), the shortest route from the stopover station (station B) to the destination station (station F) and the associated timetable searched again on the display screen of the display unit 25.

In subsequent Step S360, the control agent AGC3 sets the information on the shortest route and the associated timetable obtained by the second search as the new action plan information, and thereafter, the jobs in Steps S320 through S360 are repeated.

Upon judgment of the user's arrival at the destination station (station F) by the control agent AGC3 based on the current position information POSI, the agent function AGNT3 terminates the job.

As has been discussed, according to the present embodiment, the circumstance monitor agent AGP3 independently retrieves the information INFOC pertinent to the circumstance of the user, and upon judging that the information INFOC affects the user, it provides the information INFOC to the user-owned cellular phone 7, thereby making it possible to provide the user with the information enabling the user to make an accurate judgment. Consequently, not only can convenience be improved further, but also elaborate assistance which meets the need or suits the purpose of the user can be provided.

(Fourth Embodiment)

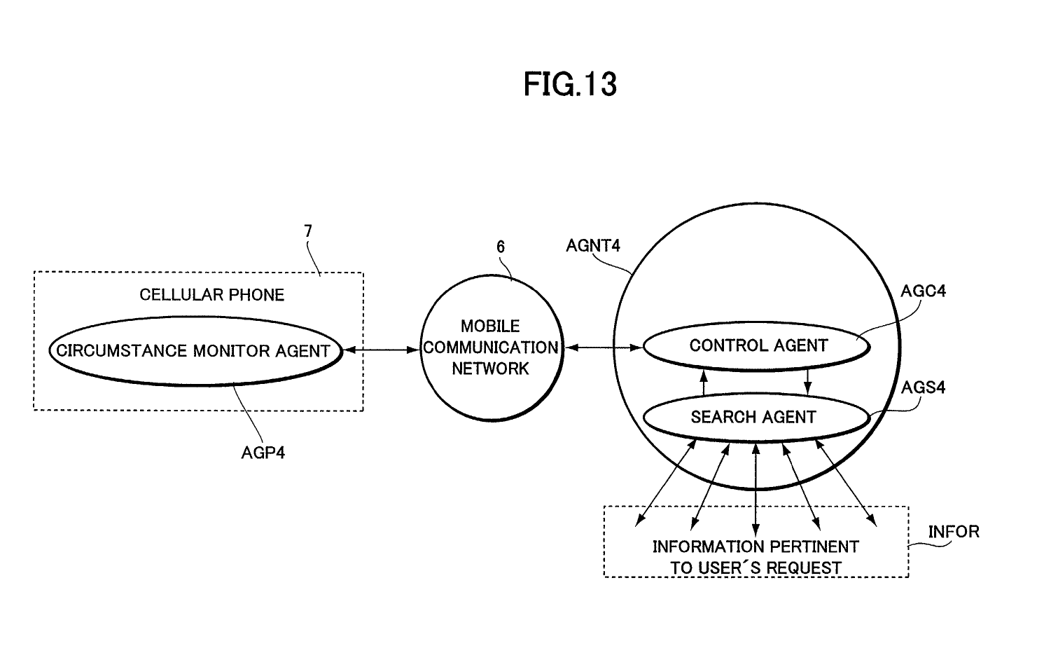

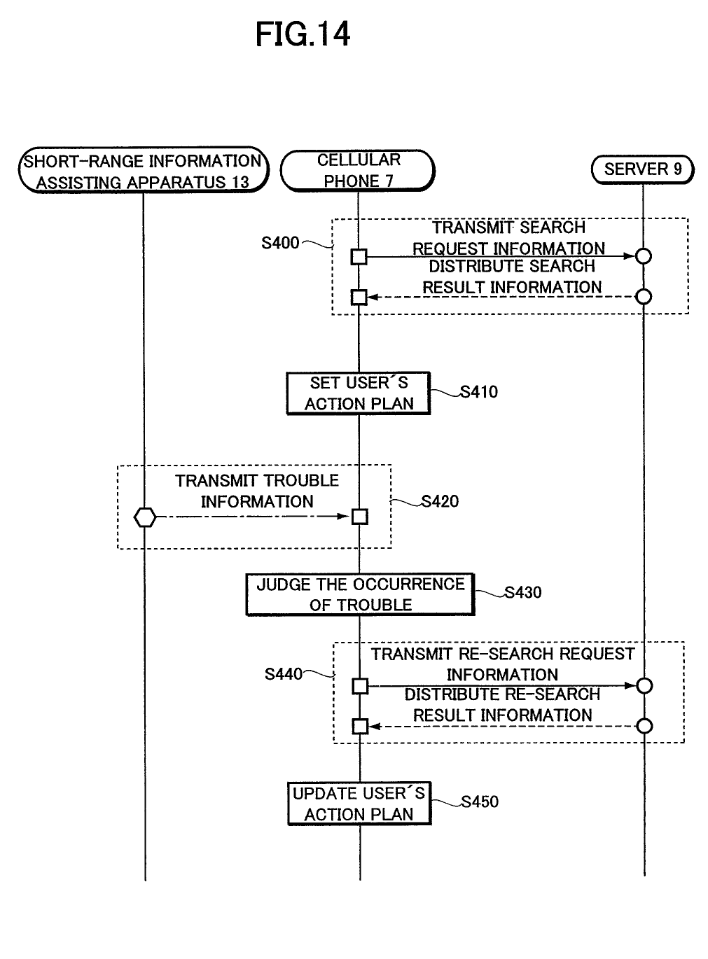

Next, the following description will describe a fourth embodiment of the present invention with reference to FIGS. 13 and 14.

An information assisting system of the present embodiment is of the same arrangement as described in the first embodiment with reference to FIGS. 1 through 3.

In the present embodiment, however, as shown in FIG. 13, an agent function AGNT4 provided to the server 9 omits a circumstance monitor agent and is composed of a control agent AGC4 for accepting a search request from the user and a search agent AGS4 for conducting a search.

It should be noted, however, that a circumstance monitor agent AGP4 for monitoring the circumstance of the user is provided to the control unit 30 of the cellular phone 7 shown in FIG. 3. In other words, the function of the circumstance monitor agent AGP4 is realized by running an object-oriented program created according to the predetermined communications protocol on a computer (microprocessor) installed in the control unit 30, which allows the cellular phone 7 by itself to monitor the circumstance of the user.

Next, the following description will describe an operation of the above-arranged information assisting system with reference to the flowchart of FIG. 14. Herein, an explanation will be given to an operation of the information assisting system in an example case where the user wishes to move from the start station (station A) to the destination station (station F) via the train routes shown in FIG. 4.

In Step S400 in FIG. 14, the user manipulates the cellular phone 7 by reviewing the screen of the display unit 25 shown in FIG. 7(a) and transmits the search request information indicating that he wishes to obtain the information on the shortest route from the start station (station A) to the destination station (station F) and an associated timetable to the server 9. Accordingly, upon receipt of the search request information at the server 9, the control agent AGC4 is activated.

Then, the control agent AGC4 specifies the cellular phone 7 which needs the assistance based on its phone number or the like. Meanwhile, the control agent AGC4 judges that the purpose of the user is to move from the start station (station A) to the destination station (station F) from the content of the search request information, and it also judges that the assistance needs to be continued until the user arrives the destination station (station F). Then, the control agent AGC4 directs the search agent AGS4 to search for the information on the shortest route from the start station (station A) to the destination station (station F) and the associated timetable which meets the search request.

Here, the search agent AGS4 searches through the servers 8, 10, 12a, 12b, 12c, etc. handling the traffic information, and obtains the information INFOR on the shortest route from the start station (station A) to the destination station (station F) and the associated timetable which meets the search request. Then, the control agent AGC4 distributes the information INFOR to the cellular phone 7 via the mobile communication network 6 as search result information.

Upon receipt of the search result information, the cellular phone 7 displays, as shown in FIG. 7(b), the search result information on the display screen of the display unit 25.

Then, in Step S410, the circumstance monitor agent AGP4 in the cellular phone 7 sets the information on the shortest route from the start station (station A) to the destination station (station F) and the associated timetable as action plan information of the user.

Then, after the jobs in Step S410 are completed, the user takes a train at the start station (station A) which is scheduled to leave at the time specified by the search result information, for example, at 10:00 a.m., and heads for the destination station (station F).

In subsequent Step S420, trouble information informing the occurrence of a trouble with the train is transmitted from the short-range information assisting apparatus 13 (see FIG. 1) installed in the user's train, and upon receipt of the trouble information by means of the short-range transmitting/receiving unit 22 (see FIG. 3), the circumstance monitor agent AGP4 provided in the control section 30 judges the occurrence of a trouble, and displays the content of the trouble information on the display unit 25 in Step S430. For example, a message shown in FIG. 10(a) is displayed according to the content of the trouble information.

In other words, the short-range information assisting apparatus 13 installed in the user's train transmits the trouble information of the train, and because the trouble information is of the kind which affects the user, the circumstance monitor agent AGP4 judges the occurrence of a trouble based on the trouble information informed by the short-range information assisting apparatus 13.

In subsequent Step S440, the user manipulates predetermined manipulation keys of the manipulation unit 26 in response to the content displayed on the display unit 25, and transmits re-search request information requesting a second search for an alternative train route. Then, the re-search request information together with the current position information POSI is transmitted to the server 9. Further, upon receipt of the re-search request information at the server 9, the control agent AGC4 directs the search agent AGS4 to search for an alternative shortest route from the position indicated by the current position information POSI to the destination station (station F) and an associated timetable.

When the alternative shortest route and the associated timetable are searched by the second search, the control agent AGC4 transmits (distributes) re-search result information to the cellular phone 7. Upon receipt of the re-search result information, the cellular phone 7 provides the same to the user by displaying, as shown in FIG. 7(d), the shortest route and the associated timetable searched again on the display screen of the display unit 25.

In subsequent Step S450, the circumstance monitor agent AGP4 sets the information on the shortest route and the associated timetable searched again as the new action plan information of the user.

Thereafter, the jobs in Steps S410 through S450 are repeated until the user arrives the destination station (station F). When the circumstance monitor agent AGP4 and the control agent AGC4 judge the user's arrival at the destination station (station F), the circumstance monitor agent AGP4 and the agent function AGNT4 terminate their respective jobs.

Herein, the circumstance monitor agent AGP4 judges the user's arrival at the destination station (station F) by comparing the current time with the action plan information, or comparing the current position information POSI with the action plan information, and the control agent AGC4 judges the user's arrival at the destination station (station F) by comparing the information INFOR on the shortest route and the associated timetable searched by the search agent AGS4 with the current time.

As has been discussed, according to the present embodiment, the circumstance monitor agent AGP4 provided to the cellular phone 7 monitors the circumstance of the user based on the trouble information transmitted from the short-range information assisting apparatus 13, and upon judging the occurrence of a trouble, it has an alternative train route and an associated timetable be searched again by the server 9 at a command from the user. Consequently, not only can the information enabling the user to make an accurate judgment be provided, but also convenience can be improved further.

(Fifth Embodiment)

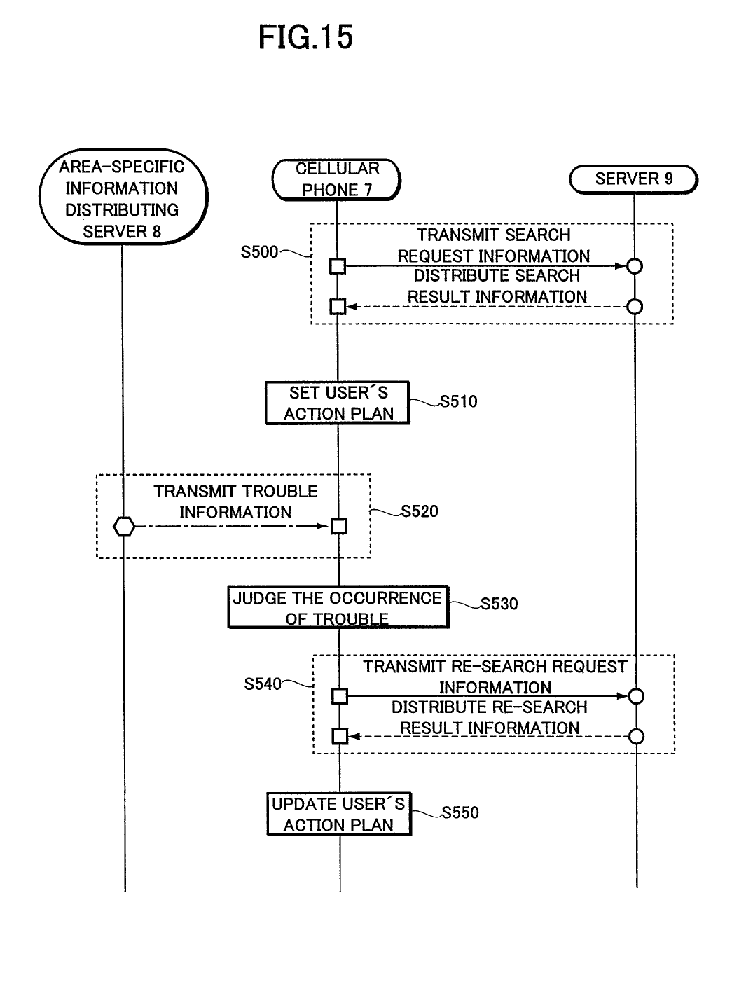

Next, the following description will describe a fifth embodiment of the present invention with reference to FIG. 15.

An information assisting system of the present embodiment is of the same arrangement as described in the first embodiment with reference to FIGS. 1 through 3. Also, the server 9 is provided with an agent function AGNT4 composed of a control agent AGC4 and a search agent AGS4 each equivalent to their respective counterparts shown in FIG. 13, and the cellular phone 7 is provided with a circumstance monitor agent AGP4 equivalent to its counterpart shown in FIG. 13.

Herein, the circumstance monitor agent AGP4 monitors the circumstance of the user by extracting information which affects the user from the information of various kinds distributed constantly from the area-specific information distributing server 8 shown in FIG. 1. In short, the cellular phone 7 by itself monitors the circumstance of the user.

Next, the following description will describe an operation of the above-arranged information assisting system with reference to the flowchart of FIG. 15. Herein, an explanation will be given to an operation of the information assisting system in an example case where the user wishes to move from the start station (station A) to the destination station (station F) via train routes shown in FIG. 4.

In Step S500 in FIG. 15, the user manipulates the cellular phone 7 by reviewing the screen of the display unit 25 shown in FIG. 7(a) and transmits the search request information indicating that he wishes to obtain the information on the shortest route from the start station (station A) to the destination station (station F) and an associated timetable to the server 9. Accordingly, upon receipt of the search request information at the server 9, the control agent AGC4 is activated.

Then, the control agent AGC4 specifies the cellular phone 7 which needs the assistance based on its phone number or the like. Meanwhile, the control agent AGC4 judges that the purpose of the user is to move from the start station (station A) to the destination station (station F) from the content of the search request information, and it also judges that the assistance needs to be continued until the user arrives the destination station (station F). Then, the control agent AGC4 directs the search agent AGS4 to search for the information on the shortest route from the start station (station A) to the destination station (station F) and the associated timetable which meets the search request.

Here, the search agent AGS4 searches through the servers 8, 10, 12a, 12b, 12c, etc. handling the traffic information, and obtains the information INFOR on the shortest route from the start station (station A) to the destination station (station F) and the associated timetable which meets search request. Then, the control agent AGC4 distributes the information INFOR to the cellular phone 7 via the mobile communication network 6 as search result information.

Upon receipt of the search result information, the cellular phone 7 displays, as shown in FIG. 7(b), the search result information on the display screen of the display unit 25.

Then, in Step S510, the circumstance monitor agent AGP4 in the cellular phone 7 sets the information on the shortest route from the start station (station A) to the destination station (station F) and the associated timetable as action plan information of the user.

Then, after the jobs in Step S510 are completed, the user takes a train at the start station (station A) which is scheduled to leave at the time specified by the search result information, for example, at 10:00 a.m., and heads for the destination station (station F).

In subsequent Step S520, when the traffic-related trouble information is transmitted from the area-specific information distributing server 8 via the mobile communication network 6, the cellular phone 7 receives the same by means of the mobile communication transmitting/receiving unit 20 (see FIG. 3). Further, in Step S530, the circumstance monitor agent AGP4 analyzes whether the trouble information affects the user, and upon so judging, it judges the occurrence of a trouble and displays the content of the trouble information on the display unit 25. For example, a message shown in FIG. 10(a) is displayed according to the content of the trouble information.

In subsequent Step S540, the user manipulates predetermined manipulation keys of the manipulation unit 26 in response to the content displayed on the display unit 25, and transmits re-search request information requesting a second search for an alternative train route. Then, the re-search request information together with the current position information POSI is transmitted to the server 9. Further, upon receipt of the re-search request information at the server 9, the control agent AGC4 directs the search agent AGS4 to search for an alternative shortest route from the position indicated by the current position information POSI to the destination station (station F) and an associated timetable.

Then, when the alternative shortest route and the associated timetable are searched by the second search, re-search result information is transmitted (distributed) from the control agent AGC4 to the cellular phone 7. Upon receipt of the re-search result information, the cellular phone 7 provides the same to the user by displaying, as shown in FIG. 7(d), the shortest route and the associated timetable searched again on the display screen of the display unit 25.

In subsequent Step S550, the circumstance monitor agent AGP4 sets the information on the shortest route and the associated timetable obtained by the second search as the new action plan information of the user.

Thereafter, the jobs in Steps S520 through S550 are repeated until the user arrives the destination station (station F). When the circumstance monitor agent AGP4 and the control agent AGC4 judge the user's arrival at the destination station (station F), the circumstance monitor agent AGP4 and the agent function AGNT4 terminate their respective jobs.

Herein, the circumstance monitor agent AGP4 judges the user's arrival at the destination station (station F) by comparing the current time with the action plan information, or comparing the current position information POSI with the action plan information, and the control agent AGC4 judges the user's arrival at the destination station (station F) by comparing the information INFOR on the shortest route and the associated timetable searched by the search agent AGS4 with the current time.

As has been discussed, according to the present embodiment, the circumstance monitor agent AGP4 provided to the cellular phone 7 monitors the circumstance of the user based on the traffic information transmitted from the area-specific information distributing server 8, and upon judging the occurrence of a trouble, it has an alternative train route and an associated timetable be searched again by the server 9 at a command from the user. Consequently, not only can the information enabling the user to make an accurate judgment be provided, but also convenience can be improved further.

(Sixth Embodiment)

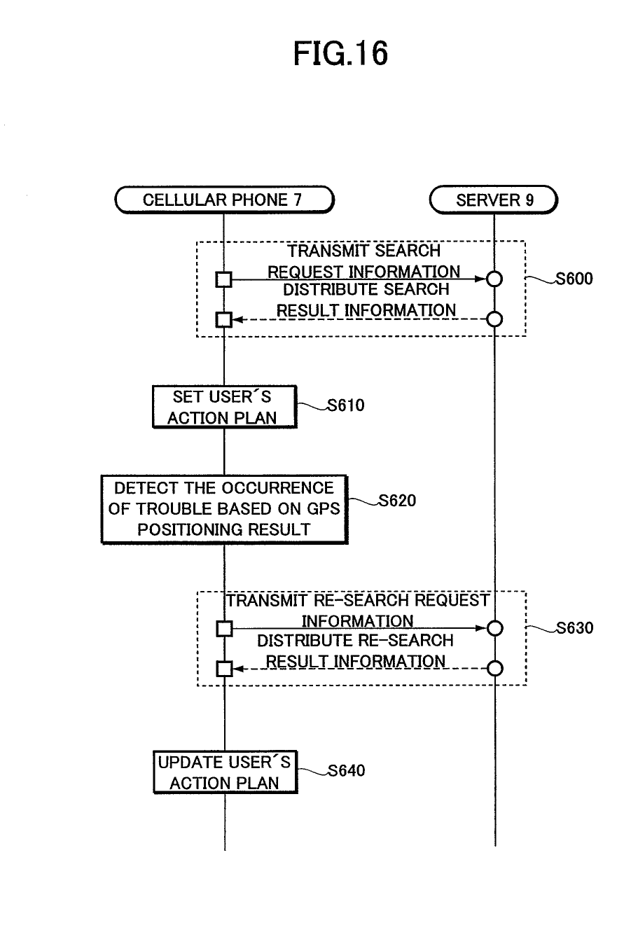

Next, the following description will describe a sixth embodiment of the present invention with reference to FIG. 16.

An information assisting system of the present invention is of the same arrangement as described in the first embodiment with reference to FIGS. 1 through 3. Also, the server 9 is provided with an agent function AGNT4 composed of a control agent AGC4 and a search agent AGS4 each equivalent to their respective counterparts shown in FIG. 13, and the cellular phone 7 is provided with a circumstance monitor agent AGP4 equivalent to its counterpart shown in FIG. 13.

Herein, the circumstance monitor agent AGP4 monitors the circumstance of the user by means of a GPS system. In short, the cellular phone 7 by itself monitors the circumstance of the user.

Next, the following description will describe an operation of the above-arranged information assisting system with reference to the flowchart of FIG. 16. Herein, an explanation will be given to an operation of the information assisting system in an example case where the user wishes to move from the start station (station A) to the destination station (station F) via train routes shown in FIG. 4.

In Step S600 in FIG. 16, the user manipulates the cellular phone 7 by reviewing the screen of the display unit 25 shown in FIG. 7(a) and transmits the search request information indicating that he wishes to obtain the information on the shortest route from the start station (station A) to the destination station (station F) and an associated timetable to the server 9. Accordingly, upon receipt of the search request information at the server 9, the control agent AGC4 is activated.

Then, the control agent AGC4 specifies the cellular phone 7 which needs the assistance based on its phone number or the like. Meanwhile, the control agent AGC4 judges that the purpose of the user is to move from the start station (station A) to the destination station (station F) from the content of the search request information, and it also judges that the assistance needs to be continued until the user arrives the destination station (station F). Then, the control agent AGC4 directs the search agent AGS4 to search for the information on the shortest route from the start station (station A) to the destination station (station F) and the associated timetable which meets the search request.

Here, the search agent AGS4 searches through the servers 8, 10, 12a, 12b, 12c, etc. handling the traffic information, and obtains the information INFOR on the shortest route from the start station (station A) to the destination station (station F) and the associated timetable which meets the search request. Then, the control agent AGC4 distributes the information INFOR to the cellular phone 7 via the mobile communication network 6 as search result information.

Upon receipt of the search result information, the cellular phone 7 displays, as shown in FIG. 7(b), the search result information on the display screen of the display unit 25.

In subsequent Step S610, the circumstance monitor agent AGP4 in the cellular phone 7 sets the information on the shortest route from the start station (station A) to the destination station (station F) and the associated timetable as action plan information of the user.

Then, after the jobs in Step S610 are completed, the user takes a train at the start station (station A) which is scheduled to leave at the time specified by the search result information, for example, at 10:00 a.m., and heads for the destination station (station F).

In subsequent Step S620, the GPS positioning unit 21 (see FIG. 3) determines the current position of the cellular phone 7 based on an arrival radio wave from the GPS satellite at every predetermined time τ, and further, it judges the occurrence of any trouble to the user by comparing the current position information POSI thus obtained with the action plan information.

In other words, a change in the current position information POSI determined and obtained at every predetermined time τ is set as actual action information of the user, and the actual action information is compared with the action plan information in terms of time and position, so that discrepancies of the actual action information with respect to the action plan information are determined quantitatively as a difference in time and a difference in position, and only when the difference in time or the difference in position exceeds their respective predetermined reference values, the detection of a trouble is judged.

Upon judgment of the occurrence of a trouble, the cellular phone 7 displays, as shown in FIG. 7(c), a message informing the occurrence of a trouble and a message requesting the user a command as to whether an alternative train route needs to be searched on the display unit 25 in Step S630.

Accordingly, the user manipulates predetermined manipulation keys of the manipulation unit 26 in response to the displayed content, and transmits re-search request information requesting a second search for an alternative train route. Then, the re-search request information together with the current position information POSI is transmitted to the server 9. Further, upon receipt of the re-search request information at the server 9, the control agent AGC4 directs the search agent AGS4 to search for an alternative shortest route from the position indicated by the current position information POSI to the destination station (station F) and an associated timetable.

Then, when the alternative shortest route and the associated timetable are found by the second search, re-search result information is transmitted (distribute) from the control agent AGC4 to the cellular phone 7. Upon receipt of the re-search result information, the cellular phone 7 provides the same to the user by displaying, as shown in FIG. 7(d), the shortest route and the associated timetable searched again on the display screen of the display unit 25.

In subsequent Step S640, the circumstance monitor agent AGP4 sets the information on the shortest route and the associated timetable obtained by the second search as the new action plan information of the user.

Thereafter, the jobs in Steps S620 through S640 are repeated until the user arrives the destination station (station F). When the circumstance monitor agent AGP4 and the control agent AGC4 judge the user's arrival at the destination station (station F), the circumstance monitor agent AGP4 and the agent function AGNT4 terminate their respective jobs.

Herein, the circumstance monitor agent AGP4 judges the user's arrival at the destination station (station F) by comparing the current time with the action plan information, or comparing the current position information POSI with the action plan information, and the control agent AGC4 judges the user's arrival at the destination station (station F) by comparing the information INFOR on the shortest route and the associated timetable searched by the search agent AGS4 with the current time.

As has been discussed, according to the present embodiment, the circumstance monitor agent AGP4 provided to the cellular phone 7 judges the occurrence of a trouble to the user by comparing the current position information POSI determined by the GPS positioning unit 21 at every predetermined time τ with the action plan information, and upon judging the occurrence of a trouble, it has an alternative train route and an associated timetable be searched again by the server 9 at a command from the user. Consequently, not only can the information enabling the user to make an accurate judgment be provided, but also convenience can be improved further.

As has been described, according to the first through sixth embodiments, the assistance is provided not by merely searching and providing the information at a assistance request (search request) from the user, but by judging the circumstance of the user by comparing the action plan with the actual action circumstance of the user, so that, upon the occurrence of a trouble which affects the action plan of the user, an alternative train route is searched again as explained above by way of example. Consequently, it is possible to provide elaborate assistance by distributing proper information continuously until the desired purpose of the user is achieved.

The first through sixth embodiments described cases where the cellular phone 7 serving as a mobile station is used as an information terminal apparatus. It should be appreciated, however, that other information terminal apparatuses, such as a PDA, can be used as well.

According to the first through sixth embodiments, when a trouble occurs, a command to continue the assistance, such as a re-search request command, is transmitted as the user follows predetermined manipulations according to the menu displayed on the display unit 25 of the cellular phone 7. However, a special manipulation key for the assistance continue command may be provided to the manipulation unit 26, so that user can enter the assistance continue command merely by manipulating the special manipulation key. This arrangement can improve the ease of operation and convenience to the user.

Also, explanations were given to the operations in example cases where the user moves to a desired site by train. It should be appreciated, however, that the present invention is applicable to the other cases. For example, the present invention is applicable to a case where the user moves from one place to another by a transportation system other than trains.

Also, it is possible to realize an information assisting system for providing assistance in such a manner that, when the user manipulates the information terminal apparatus, such as the cellular phone, and notifies the current position and a position in the future, the agent function judges the circumstance of the user, notifies the user of the information pertinent to a trouble which affects the user, or examines a trouble-avoiding method in assisting the user.

The arrangements of the agent functions described in the first through sixth embodiments are given by way of example, and all the control agent, circumstance monitor agent, and search agent may be provided in the information terminal apparatus, such as a cellular phone, so that the information terminal apparatus by itself assists the user. In short, the present invention encompasses any information assisting system provided with an agent function which judges the circumstance of the user by comparing the action plan with the actual action circumstance of the user, and continues to assist the user in a suitable manner until the desired purpose of the user is achieved after a trouble which affects the action plan of the user occurs.

The present invention also includes a system, in which the agent recognizes the normal actions of the user and predicts his next action from the time and location, so that the agent assists the user by providing proper information if the user does not set his destination. The present invention also includes a system which analyzes schedule or the like the user has set if his action is different from his normal actions, and provides the information in line with his normal actions in assisting the user.

As has been described, according to the information assisting system, information assisting method, information terminal apparatus, and information assisting apparatus of the present invention, positioning means for determining a current position of the information terminal apparatus and agent means provided to at least one of the information terminal apparatus and the information assisting apparatus are furnished, wherein the agent means compares the information on the action plan of the user with the information on the current position of the information terminal apparatus which moves along with the user, and judges the circumstance of the user. Upon judging the occurrence of a trouble which affects the action plan of the user, the agent function provides the user with proper information and continues to assist the user in a suitable manner until the desired purpose of the user is achieved. Consequently, it is possible to improve convenience to the user.

While there has been described what are at present considered to be preferred embodiments of the present invention, it will be understood that various modifications may be made thereto, and it is intended that the appended claims cover all such modifications as fall within the true spirit and scope of the invention.

What is claimed is:

1. An information assisting system employing a mobile communication network, comprising:
an information terminal apparatus and an information assisting apparatus communicating with each other via said mobile communication network;
positioning device provided to said information terminal apparatus, for determining a current position of said information terminal apparatus; and
agent device provided to at least one of said information terminal apparatus and said information assisting apparatus,
wherein said agent device retrieves information pertinent to the current position of said information terminal apparatus from said information assisting apparatus, based on the information on the current position determined by said positioning device, and supplies the retrieved information to said information terminal apparatus.

2. The information assisting system according to claim 1, wherein said agent device sets information on an action plan of a user inputted from said information terminal apparatus, compares the action plan information with the current position information determined at every predetermined time by said positioning device, and judges an occurrence of a trouble brought to the user when the information on the current position has a discrepancy in time or in position with respect to the information on said action plan.

3. The information assisting system according to claim 1, wherein said agent device sets information on an action plan of a user inputted from said information terminal apparatus, conducts a search through said information assisting apparatus at every predetermined time to obtain information pertinent to the information on said action plan, and judges a circumstance of the user by comparing the information obtained by said search with information on the current position determined by said positioning device.

4. The information assisting system according to claim 3, wherein said agent device judges an occurrence of a trouble to the user upon judging that the information obtained by said search includes information pertinent to the information on the current position determined by said positioning device, said agent device's judgment being performed by comparing the information obtained by said search with the information on the current position determined by said positioning device.

5. The information assisting system according to claim 3, wherein, after said agent device sets the information on said action plan of the user inputted from said information terminal apparatus, said agent device judges the circumstance of the user and an occurrence of a trouble to the user upon supply of information affecting the user from said information assisting apparatus and based on the information supplied.

6. The information assisting system according to claim 2, wherein, upon judging the occurrence of a trouble, said agent device retrieves information pertinent to said trouble from said information assisting apparatus, and supplies said information terminal apparatus with the information retrieved.

7. The information assisting system according to claim 3, wherein, upon judging the occurrence of a trouble, said agent device retrieves information pertinent to said trouble from said information assisting apparatus, and supplies said information terminal apparatus with the information retrieved.

8. The information assisting system according to claim 2, wherein, when the user enters an assistance continue command in response to the information pertinent to said trouble supplied to said information terminal apparatus, said agent device sets information on an action plan from a position at which said information terminal apparatus was present when said assistance continue command was entered.

9. The information assisting system according to claim 3, wherein, when the user enters an assistance continue command in response to the information pertinent to said trouble supplied to said information terminal apparatus, said agent device sets information on an action plan from a position at which said information terminal apparatus was present when said assistance continue command was entered.

10. The information assisting system according to claim 1, wherein said information assisting apparatus is provided with storage device for storing information on a timetable of a vehicle traveling according to a predetermined timetable between arbitrary points in a transportation network.

11. The information assisting system according to claim 10, wherein said agent device finds, from the information on the timetable stored in said storage device, an action plan route extending from a start point to a destination of travel and specified by a user with said information terminal apparatus, and upon judging an occurrence of a trouble to the user while the user is moving along said action plan route, said agent device finds, from the information on the timetable stored in said storage device, an alternative action plan route extending from a point at which judgment was made to the destination of travel.

12. An information assisting method employing an information terminal apparatus and an information assisting apparatus communicating with each other via a mobile communication network, wherein:
a current position of said information terminal apparatus is determined; and
information pertinent to the current position determined is retrieved from said information assisting apparatus and supplied to said information terminal apparatus.

13. The information assisting method according to claim 12, wherein:
information on the current position of said information terminal apparatus is determined at every predetermined time;
the information on the current position determined is compared with information on an action plan of a user inputted into said information terminal apparatus; and
an occurrence of a trouble to the user is judged when the information on the current position causes a discrepancy in time or in position with respect to the information on said action plan.

14. The information assisting method according to claim 12, wherein:
a search is conducted through said information assisting apparatus at every predetermined time to obtain information pertinent to information on an action plan of a user inputted into said information terminal apparatus; and
a circumstance of the user is judged by comparing the information obtained by said search with information on the current position of said information terminal apparatus.

15. The information assisting method according to claim 14, wherein by comparing the information obtained by said search with the information on the current position determined by the positioning device, an occurrence of a trouble to the user is judged when the information obtained by said search is judged to have included information pertinent to the information on the current position.

16. The information assisting method according to claim 13, wherein after the information on said action plan of the user inputted from said information terminal apparatus is set, when there is a supply of information affecting the user from said information assisting apparatus to said information terminal apparatus, a circumstance of the user and the occurrence of a trouble to the user are judged based on the information supplied.

17. The inf ormation assisting method according to claim 13, wherein, when the occurrence of a trouble is judged, information pertinent to said trouble is retrieved from said information assisting apparatus and supplied to said information terminal apparatus.

18. The inf ormation assisting method according to claim 14, wherein, when the occurrence of a trouble is judged, information pertinent to said trouble is retrieved from said information assisting apparatus and supplied to said information terminal apparatus.

19. The information assisting method according to claim 13, wherein, when the user enters an a ssistance c ontinue command in response to the information pertinent to said trouble supplied to said information terminal apparatus, information is set which is related to an action plan from a position at which said information terminal apparatus was present when said assistance continue command was entered.

20. The information assisting method according to claim 14, wherein, when the user enters an assistance continue command in response to the information pertinent to said trouble supplied to said information terminal apparatus, information is set which is related to an action plan from a position at which said information terminal apparatus was present when said assistance continue command was entered.

21. An information terminal apparatus used in an information assisting system employing a mobile communication network, comprising:
positioning device which determines a current position of said information terminal apparatus; and
agent device which retrieves information pertinent to the current position from an information assisting apparatus network-connected with said mobile communication network, based on information on the current position determined by said positioning device, and supplies said retrieved information to a user.

22. The information terminal apparatus according to claim 21, wherein said agent device has the current position be determined at every predetermined time by said positioning device, compares the determined information on the current position with information on an action plan of the user inputted into said information terminal apparatus, and judges an occurrence of a trouble to the user when the information on the current position causes a discrepancy in time or in position with respect to the information on said action plan.

23. The information terminal apparatus according to claim 22, wherein said agent device conducts a search through said information assisting apparatus at every predetermined time to obtain information pertinent to the information on said action plan, and judges a circumstance of the user by comparing the information obtained by said search with the information on the current position of said information terminal apparatus.

24. The information terminal apparatus according to claim 23, wherein said agent device judges the occurrence of a trouble to the user upon judging that the information obtained by said search includes information pertinent to the information on the current position, by comparing the information obtained by said search with the information on the current position determined by said positioning device.

25. The information terminal apparatus according to claim 22, wherein,
after the information on said action plan of the user inputted from said information terminal apparatus is set, when there is a supply of information affecting the user from said information assisting apparatus to said information terminal apparatus, a circumstance of the user and the occurrence of a trouble to the user are judged based on the information supplied.

26. The information terminal apparatus according to claim 22, wherein upon judging the occurrence of a trouble, said agent device retrieves information pertinent to said trouble from said information assisting apparatus, and supplies the retrieved information to said information terminal apparatus.

27. The information terminal apparatus according to claim 22, wherein, when the user enters an assistance continue command in response to the information pertinent to said trouble supplied to said information terminal apparatus, said agent device sets information on an action plan from a current position at which said information terminal apparatus was present when said assistance continue command was entered.

28. The information terminal apparatus according to claim 21, wherein said agent device has the current position determined at every predetermined time by said positioning device, supplies said information assisting apparatus with information on the current position determined and information on an action plan of the user inputted into the information terminal apparatus, and judges an occurrence of a trouble to the user when a discrepancy in time or in position is found by comparing the information on the current position with the information on said action plan.

29. The information terminal apparatus according to claim 28, wherein said agent device has a search conducted by said information assisting apparatus at every predetermined time to obtain information pertinent to the information on said action plan, and judges a circumstance of the user by comparing the information obtained by said search with the information on the current position of said information terminal apparatus.

30. The information terminal apparatus according to claim 29, wherein said agent device renders the information assisting apparatus to compare the information obtained by said search with the information on the current position determined by said positioning device, and judges the occurrence of a trouble to the user upon judging that the information obtained by said search includes information pertinent to the information on the current position.

31. The information terminal apparatus according to claim 28, wherein, after said agent device sets the information on said action plan of the user inputted from said information terminal apparatus, and upon supply of information affecting the user from said information assisting apparatus, said agent device judges the circumstance of the user and renders information pertinent to said trouble affecting the user to be retrieved from said information assisting apparatus based on the information supplied.

32. The information terminal apparatus according to claim 29, wherein, when the user enters an assistance continue command in response to the information pertinent to said trouble, said agent device sets information on an action plan from a position at which said information terminal apparatus was present when said assistance continue command was entered.

33. An information assisting apparatus used in an information assisting system employing a mobile communication network, comprising:
agent device which compares information on a current position of an information terminal apparatus transmitted at every predetermined time from said information terminal apparatus network-connected with said mobile communication network, with information on an action plan of a user inputted into said information terminal apparatus, and judges an occurrence of a trouble to the user when the information on the current position causes a discrepancy in time or in place with respect to the information on said action plan.

34. An information assisting apparatus used in an information assisting system employing a mobile communication network, comprising:
agent device which receives information on an action plan of a user from an information terminal apparatus network-connected with said mobile communication network, conducts a search at every predetermined time to obtain information pertinent to the information on said action plan, and judges a circumstance of the user by comparing the information obtained by said search with information on a current position of said information terminal apparatus.

35. The information assisting apparatus according to claim 34, wherein said agent device judges an occurrence of a trouble to the user upon judging that the information obtained by said search includes information pertinent to the information on the current position, by comparing the information obtained by said search with the information on the current position.

36. The information assisting apparatus according to claim 33, wherein, when the user enters an assistance continue command in response to information pertinent to said trouble, said agent device sets information on an action plan from a position at which said information terminal apparatus was present when said assistance continue command was entered.

37. The information assisting apparatus according to claim 34, wherein, when the user enters an assistance continue command in response to information pertinent to said trouble, said agent device sets information on an action plan from a position at which said information terminal apparatus was present when said assistance continue command was entered.
